(19) United States
(12) Patent Application Publication
(10) Pub. No.: US 2026/0078302 A1
(43) Pub. Date: Mar. 19, 2026

(54) LIQUID CRYSTAL COMPOSITION AND DISPLAY PANEL

(71) Applicant: TCL CHINA STAR OPTOELECTRONICS TECHNOLOGY CO., LTD., Shenzhen (CN)

(72) Inventors: Jing ZHOU, Shenzhen (CN); Xiao LIU, Shenzhen (CN); Guoren LUO, Shenzhen (CN); Ji LI, Shenzhen (CN)

(73) Assignee: TCL CHINA STAR OPTOELECTRONICS TECHNOLOGY CO., LTD., Shenzhen (CN)

(21) Appl. No.: 19/022,163

(22) Filed: Jan. 15, 2025

Related U.S. Application Data
(63) Continuation of application No. PCT/CN2024/126275, filed on Oct. 22, 2024.

(30) Foreign Application Priority Data
Sep. 19, 2024 (CN) 202411310537.8

(51) Int. Cl. C09K 19/46; C09K 19/04

(52) U.S. Cl. CPC C09K 19/46; C09K 2019/0448

(57) ABSTRACT

A liquid crystal composition includes at least one first compound that is represented by the following formula I. In formula I,

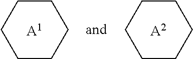

are independently selected from an aromatic ring, a heteroaromatic ring, a fused ring, an aliphatic ring, or an alicyclic heterocyclic ring, and one or more H atoms in these groups are unsubstituted or independently substituted by L⁰; Z¹, Z², and Z³ are independently selected from a single bond, —O—, —S—, —CO—, —C(O)O—, —OC(O)—, —CF₂O—, —OCF₂—, —CH₂CH₂—, —CH₂O—, —OCH₂—, —CH═CH—, —C≡C—, an alkylidene group having 1-10 carbon atoms, an alkenylidene group having 2-10 carbon atoms, or an alkynyl group having 2-10 carbon atoms; and L⁰, L¹, L², and L³ are independently selected from —F, —Cl, —Br, —I, —CN, —NO₂, —NCO, —NCS, —OCN, —SCN, a linear or branched alkyl group having 1-5 carbon atoms, or an alkoxy group having 1-5 carbon atoms.

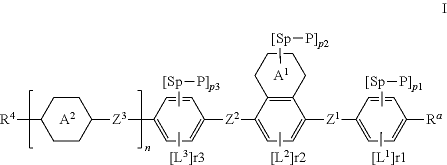

### CROSS-REFERENCE TO RELATED APPLICATION

This application is a continuation application of International Application No. PCT/CN2024/126275, filed on Oct. 22, 2024, which claims priority to and the benefit of Chinese Patent Application No. 202411310537.8, filed on Sep. 19, 2024, the disclosures of which are incorporated herein by reference in their entirety.

### TECHNICAL FIELD

The disclosure relates to the field of display, and in particular, to a liquid crystal composition and a display panel.

### BACKGROUND

The manufacturing process of a liquid crystal display panel generally includes four processes that includes a first process for preparing an array substrate, a second process for preparing a cell, a third process for preparing polyimide (PI) alignment layers, and a fourth process for preparing a module, in which the third process for preparing the PI alignment layers may directly affect the display performance of the liquid crystal display including the liquid crystal display panel.

### SUMMARY

In a first aspect, some embodiments of the disclosure provide a liquid crystal composition including at least one first compound represented by the following formula I:

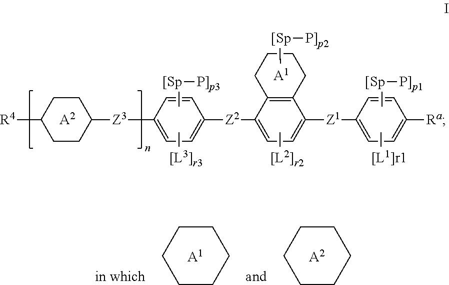

are independently selected from an aromatic ring, a heteroaromatic ring, a fused ring, an aliphatic ring, or an alicyclic heterocyclic ring; and one or more H atoms in

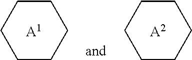

are unsubstituted or independently substituted by L⁰;
Z¹, Z², and Z³ are independently selected from a single bond, —O—, —S—, —CO—, —C(O)O—, —OC(O)—, —CF₂O—, —OCF₂—, —CH₂CH₂—, —CH₂O—, —OCH₂—, —CH═CH—, —C≡C—, an alkylidene group having 1-10 carbon atoms, an alkenylidene group having 2-10 carbon atoms, or an alkynyl group having 2-10 carbon atoms; one or more —CH₂— groups not connected together in Z¹, Z², and Z³ are not replaced, or, one or more —CH₂— groups not connected together in Z¹, Z², and Z³ are independently replaced by —O—, —S—, —CO—, —C(O)O—, —OC(O)—, —CF₂O—, —OCF₂—, —CH₂CH₂—, —CH₂O—, —OCH₂—, —CH═CH—, or —C≡C—; and one or more H atoms in Z¹, Z², and Z³ are unsubstituted, or, one or more H atoms in Z¹, Z², and Z³ are independently substituted by F, Cl, Br, or I;
L⁰, L¹, L², and L³ are independently selected from —F, —Cl, —Br, —I, —CN, —NO₂, —NCO, —NCS, —OCN, —SCN, a linear or branched alkyl group having 1-5 carbon atoms, or an alkoxy group having 1-5 carbon atoms; and one or more H atoms in L¹, L¹, L², and L³ are unsubstituted, or, one or more H atoms in L⁰, L¹, L², and L³ are independently substituted by F or Cl;
P is a polymerizable group;
Sp is independently selected from a spacer group or a single bond;
R⁴ is selected from an alkyl group having 1-15 carbon atoms, an alkoxy group having 1-15 carbon atoms, a cycloalkyl group having 3-15 carbon atoms, an alkenyl group having 2-15 carbon atoms, an alkenyloxy group having 2-15 carbon atoms, an alkynyl group having 2-15 carbon atoms, an alkynyloxy group having 2-15 carbon atoms, or

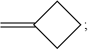

one or more —CH₂— groups in R⁴ are not replaced, or, one or more —CH₂— groups in R⁴ are independently replaced by —CH═CH—, —C≡C—, —CF₂O—,

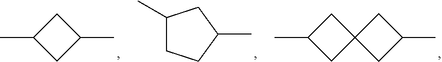

—CO—, —C(O)O—, —OC(O)—, or —O—; and one or more H atoms in R⁴ are unsubstituted, or, one or more H atoms in R⁴ are independently substituted by F, Cl, Br, or I;
R^{a} is independently selected from a group capable of anchoring to a substrate;
n is selected from 0, 1, or 2;
p1, p2, and p3 are independently selected from 1, 2, or 3; and
r1, r2, and r3 are independently selected from 0, 1, 2, or 3.

In a second aspect, some embodiments of the disclosure provide a display panel, including:
a first substrate;
a second substrate disposed on the first substrate; and
a liquid crystal layer disposed between the first substrate and the second substrate;
in which the liquid crystal layer includes a liquid crystal composition including at least one first compound represented by the following formula I:

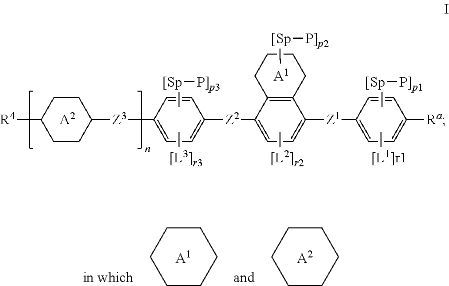

are independently selected from an aromatic ring, a heteroaromatic ring, a fused ring, an aliphatic ring, or an alicyclic heterocyclic ring; and one or more H atoms in

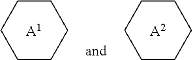

are unsubstituted or independently substituted by L⁰;
Z¹, Z², and Z³ are independently selected from a single bond, —O—, —S—, —CO—, —C(O)O—, —OC(O)—, —CF₂O—, —OCF₂—, —CH₂CH₂—, —CH₂O—, —OCH₂—, —CH═CH—, —C≡C—, an alkylidene group having 1-10 carbon atoms, an alkenylidene group having 2-10 carbon atoms, or an alkynyl group having 2-10 carbon atoms; one or more —CH₂— groups not connected together in Z¹, Z², and Z³ are not replaced, or, one or more —CH₂— groups not connected together in Z¹, Z², and Z³ are independently replaced by —O—, —S—, —CO—, —C(O)O—, —OC(O)—, —CF₂O—, —OCF₂—, —CH₂CH₂—, —CH₂O—, —OCH₂—, —CH═CH—, or —C≡C—; and one or more H atoms in Z¹, Z², and Z³ are unsubstituted, or, one or more H atoms in Z¹, Z², and Z³ are independently substituted by F, Cl, Br, or I;
L⁰, L¹, L², and L³ are independently selected from —F, —Cl, —Br, —I, —CN, —NO₂, —NCO, —NCS, —OCN, —SCN, a linear or branched alkyl group having 1-5 carbon atoms, or an alkoxy group having 1-5 carbon atoms; and one or more H atoms in L⁰, L¹, L², and L³ are unsubstituted, or, one or more H atoms in L⁰, L¹, L², and L³ are independently substituted by F or Cl;
P is a polymerizable group;
Sp is independently selected from a spacer group or a single bond;
R⁴ is selected from an alkyl group having 1-15 carbon atoms, an alkoxy group having 1-15 carbon atoms, a cycloalkyl group having 3-15 carbon atoms, an alkenyl group having 2-15 carbon atoms, an alkenyloxy group having 2-15 carbon atoms, an alkynyl group having 2-15 carbon atoms, an alkynyloxy group having 2-15 carbon atoms, or

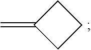

one or more —CH₂— groups in R⁴ are not replaced, or, one or more —CH₂— groups in R⁴ are independently replaced by —CH═CH—, —C≡C—, —CF₂O—,

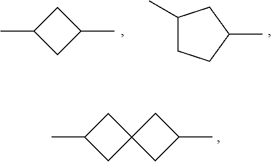

—CO—, —C(O)O—, —OC(O)—, or —O—; and one or more H atoms in R⁴ are unsubstituted, or, one or more H atoms in R⁴ are independently substituted by F, Cl, Br, or I;
R^{a} is independently selected from a group capable of anchoring to a substrate;
n is selected from 0, 1, or 2;
p1, p2, and p3 are independently selected from 1, 2, or 3; and
r1, r2, and r3 are independently selected from 0, 1, 2, or 3.

### BRIEF DESCRIPTION OF THE DRAWINGS

In order to explain technical solutions in embodiments of the disclosure more clearly, the following will briefly introduce the drawings needed to be used in description of the embodiments. Apparently, the drawings in the following description are some embodiments of the disclosure. For ordinary skilled in the art, other drawings can be obtained from these drawings without paying creative effort.

FIG. 1 is a flowchart of a method for preparing a liquid crystal composition according to some embodiments of the disclosure.

FIG. 2 is a schematic structural diagram of a display panel according to some embodiments of the disclosure.

Reference characters: 100, display panel; 101, first substrate; 102, second substrate; and 103, liquid crystal layer.

### DETAILED DESCRIPTION

The following will provide a clear and complete description of the technical solutions in the embodiments of the disclosure, in conjunction with the drawings. Apparently, the described embodiments are only a part of the embodiments of the disclosure, not all of them. Based on the embodiments of the disclosure, all other embodiments obtained by those skilled in the art without creative labor are within the scope of protection of the disclosure. Furthermore, it can be understood that the specific embodiments described herein are only for illustration and explanation of the disclosure and are not intended to limit the disclosure.

Unless otherwise specified, all technical and scientific terms used herein have the same meanings as understood by an ordinary person skilled in the art belonging to the disclosure. In addition, the terms used in the disclosure are only for the purpose of describing specific embodiments and are not intended to limit the disclosure.

In the disclosure, the directional terms, such as “on” and “below”, generally refer to upward and downward directions of the device, in actual use or working state, or in particular directions in the drawings, unless otherwise specified. In addition, the term “include” refers to “include, but not limited to”. Furthermore, the terms “first”, “second”, “third”, and the like, are only used for the purpose of description and are not intended to limit the disclosure.

In the disclosure, the term “at least one” refers to one or more, and the term “a plurality of” refers to two or more than two. In addition, the term “one or more”, “at least one of”, or similar descriptions thereof refer to any combination of these items, including any combination of a single item or plural items. For example, both of “at least one of a, b, or c” and “at least one of a, b, and c” indicate any combination of a, b, c, a-b (a and b), a-c (a and c), b-c (b and c), and a-b-c (a, b, and c).

Various embodiments of the disclosure may exist in the form of a scope. It can be understood that the description in the form of a scope is only for convenience and conciseness, and should not be construed as a limitation on the scope of the disclosure. Therefore, it should be considered that the scope described has disclosed all possible sub ranges and single values within that range. For example, the description of the range from 1 to 6 has disclosed sub ranges, such as from 1 to 3, from 1 to 4, from 1 to 5, from 2 to 4, from 2 to 6, from 3 to 6, and the like, as well as single numbers within the range, such as 1, 2, 3, 4, 5, and 6. In addition, when a numerical range is indicated in the disclosure, it refers to any referenced numbers (fractions or integers) within the indicated range.

In the disclosure, the technical features described in an open form include both closed-form technical solutions composed of the listed features and open-form technical solutions including the listed features.

In the disclosure, “substituted” means that a hydrogen atom in a group to be substituted is substituted by a substituent group.

In the disclosure, “substituted or unsubstituted” means that a defined group may be substituted or not be substituted. When the defined group is substituted, it can be understood that the defined group may be substituted by one or more substituent groups. In disclosure, unless otherwise specified, “substituted or unsubstituted” means that a hydrogen atom is substituted by F, Cl, Br, or I.

In the disclosure, in a formula including a group of

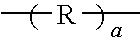

or a group of

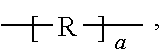

“( )” and “[ ]” in the groups both indicate that R group is a repeating unit, and “a” represents the number of repeating units of the R groups.

In the disclosure, one or more end groups in a group are not replaced, or one or more end groups in the group are independently replaced by a substituent group, indicating that, one or more end groups in a group are not replaced at each occurrence, or one or more end groups in the group are independently replaced by a substituent group at each occurrence. For example, one or more end groups in R are not replaced, or, one or more end groups in R are independently replaced by —OH, —CN, or —CF₃, indicating that, one or more end groups in R are not replaced at each occurrence, or, one or more end groups in R are independently replaced by —OH, —CN, or —CF₃ at each occurrence.

In the disclosure, one or more H atoms in a group are unsubstituted, or one or more H atoms in the group are independently substituted by a substituent group, indicating that, one or more H atoms in a group are unsubstituted at each occurrence, or one or more H atoms in the group are independently substituted by a substituent group at each occurrence. For example, one or more H atoms in R are unsubstituted, or, one or more H atoms in R are independently substituted by F, Cl, Br, or I, indicating that, one or more H atoms in R are unsubstituted at each occurrence, or, one or more H atoms in R are independently substituted by F, Cl, Br, or I at each occurrence.

In the disclosure, one or more —CH₂— groups in a group are not replaced, or one or more —CH₂— groups in the group are independently replaced by a substituent group, indicating that, one or more —CH₂— groups in a group are not replaced at each occurrence, or one or more —CH₂— groups in the group are independently replaced by a substituent group at each occurrence. For example, one or more —CH₂— groups in R are not replaced, or, one or more —CH₂— groups in R are independently replaced by —O—, —S—, —CO—, —C(O)O—, —OC(O)—, —CF₂O—, —OCF₂—, —CH₂CH₂—, —CH₂O—, —OCH₂—, —CH═CH—, or —C≡C—, indicating that, one or more —CH₂— groups in R are not replaced at each occurrence, or, one or more —CH₂— groups in R are independently replaced by —O—, —S—, —CO—, —C(O)O—, —OC(O)—, —CF₂O—, —OCF₂—, —CH₂CH₂—, —CH₂O—, —OCH₂—, —CH═CH—, or —C≡C— at each occurrence.

Traditional manufacturing processes for preparing PI alignment layers have problems such as complex processes, high cost, and affecting display performance. Specifically, in the process for preparing the PI alignment layers, precise control of the coating and curing of the PI alignment layers is required to ensure the consistency of the arrangement of liquid crystals, so as to achieve high-quality display effect. But there are problems of complex manufacturing processes and difficult operations.

In order to improve the above problem(s), some embodiments of the disclosure provide a liquid crystal composition, which includes at least one first compound represented by the following formula I:

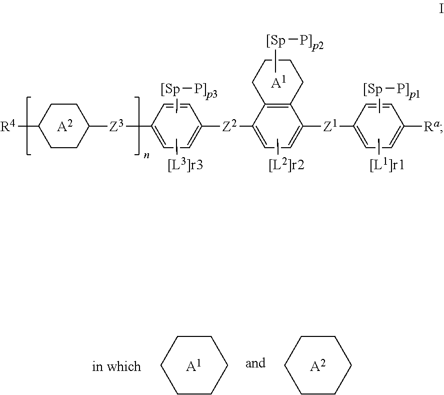

are independently selected from an aromatic ring, a heteroaromatic ring, a fused ring, an aliphatic ring, or an alicyclic heterocyclic ring; and one or more H atoms in

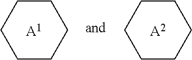

are unsubstituted or independently substituted by L⁰;
Z¹, Z², and Z³ are independently selected from a single bond, —O—, —S—, —CO—, —C(O)O—, —OC(O)—, —CF₂O—, —OCF₂—, —CH₂CH₂—, —CH₂O—, —OCH₂—, —CH═CH—, —C≡C—, an alkylidene group having 1-10 carbon atoms, an alkenylidene group having 2-10 carbon atoms, or an alkynyl group having 2-10 carbon atoms; one or more —CH₂— groups not connected together in Z¹, Z², and Z³ are not replaced, or, one or more —CH₂— groups not connected together in Z¹, Z², and Z³ are independently replaced by —O—, —S—, —CO—, —C(O)O—, —OC(O)—, —CF₂O—, —OCF₂—, —CH₂CH₂—, —CH₂O—, —OCH₂—, —CH═CH—, or —C≡C—; and one or more H atoms in Z¹, Z², and Z³ are unsubstituted, or, one or more H atoms in Z¹, Z², and Z³ are independently substituted by F, Cl, Br, or I;
L⁰, L¹, L², and L³ are independently selected from —F, —Cl, —Br, —I, —CN, —NO₂, —NCO, —NCS, —OCN, —SCN, a linear or branched alkyl group having 1-5 carbon atoms, or an alkoxy group having 1-5 carbon atoms; and one or more H atoms in L⁰, L¹, L², and L³ are unsubstituted, or, one or more H atoms in L⁰, L¹, L², and L³ are independently substituted by F or Cl;
P is a polymerizable group;
Sp is independently selected from a spacer group or a single bond;
R⁴ is selected from an alkyl group having 1-15 carbon atoms, an alkoxy group having 1-15 carbon atoms, a cycloalkyl group having 3-15 carbon atoms, an alkenyl group having 2-15 carbon atoms, an alkenyloxy group having 2-15 carbon atoms, an alkynyl group having 2-15 carbon atoms, an alkynyloxy group having 2-15 carbon atoms, or

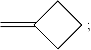

one or more —CH₂— groups in R⁴ are not replaced, or, one or more —CH₂— groups in R⁴ are independently replaced by —CH═CH—, —C≡C—, —CF₂O—,

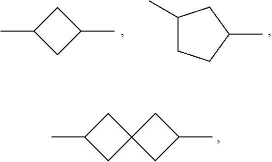

—CO—, —C(O)O—, —OC(O)—, or —O—; and one or more H atoms in R⁴ are unsubstituted, or, one or more H atoms in R⁴ are independently substituted by F, Cl, Br, or I;
R^{a} is independently selected from a group capable of anchoring to a substrate;
n is selected from 0, 1, or 2;
p1, p2, and p3 are independently selected from 1, 2, or 3; and
r1, r2, and r3 are independently selected from 0, 1, 2, or 3.

In the liquid crystal composition provided by the embodiments of the disclosure, by adding the first compound represented by formula I, the benzene ring of the main chain of the formula I is connected to a multi-membered ring with large steric hindrance, so that the multi-membered ring can serve as electron donor to increase the electron cloud density of the main chain of the formula I, reducing the light energy threshold required for the alignment of liquid crystals, and achieving self-alignment of the liquid crystals without the process for preparing the PI alignment layers. Moreover, after the self-alignment of the liquid crystals is completed, the addition of the first compound also stabilizes the ion concentration of the liquid crystal system, thereby improving the reliability of substrates. In addition, since the first compound contains a large number of polar groups, the liquid crystal composition has a larger negative dielectric anisotropy, which is conducive to improving the contrast ratio of a display panel using the liquid crystal composition.

In some embodiments, the multi-membered ring connected to the main chain of the formula I is a three-membered ring, a four-membered ring, or a five-membered ring, which have larger rigidity and are conducive to achieving vertical alignment of liquid crystals.

In some embodiments, Sp-P in formula I is represented by the following formula III or formula IV, in which the spacer group is represented by —Z⁴— in formula III and formula IV, and the polymerizable group is represented by

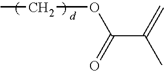

in formula III and

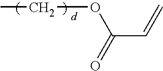

in formula IV;

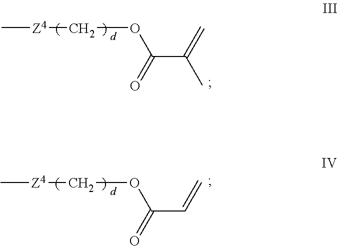

in which Z⁴ is independently selected from a single bond, —O—, —S—, —CO—, —C(O)O—, —OC(O)—, —CF₂O—, —OCF₂—, —CH₂CH₂—, —CH₂O—, —OCH₂—, —CH═CH—, —C≡C—, an alkylidene group having 1-10 carbon atoms, an alkenylidene group having 2-10 carbon atoms, or an alkynyl group having 2-10 carbon atoms; one or more —CH₂— groups not connected together in Z⁴ are not replaced, or, one or more —CH₂— groups not connected together in Z⁴ are independently replaced by —O—, —S—, —CO—, —C(O)O—, —OC(O)—, —CF₂O—, —OCF₂—, —CH₂CH₂—, —CH₂O—, —OCH₂—, —CH═CH—, —C≡C—; and one or more H atoms in Z⁴ are unsubstituted, or, one or more H atoms in Z⁴ are independently substituted by F, Cl, Br, or I; and
d is any integer from 0 to 10.

In the above embodiments, the Sp-P group of formula I is a polymerizable group, which have an anchoring effect, allowing the liquid crystals to form a pre-tilt angle on surfaces of the substrates, thereby achieving the alignment of the liquid crystals.

In some embodiments, R^{a} is represented by the following formula V:

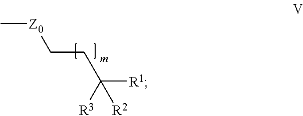

in which Z₀ is selected from a single bond, —O—, —S—, —CO—, —C(O)O—, —OC(O)—, —CF₂O—, —OCF₂—, —CH₂CH₂—, —CH₂O—, —OCH₂—, —CH═CH—, —C≡C—, an alkylidene group having 1-10 carbon atoms, an alkenylidene group having 2-10 carbon atoms, or an alkynyl group having 2-10 carbon atoms; one or more —CH₂— groups not connected together in Z₀ are not replaced, or, one or more —CH₂— groups not connected together in Z₀ are independently replaced by —O—, —S—, —CO—, —C(O)O—, —OC(O)—, —CF₂O—, —OCF₂—, —CH₂CH₂—, —CH₂O—, —OCH₂—, —CH═CH—, or —C≡C—; and one or more H atoms in Z₀ are unsubstituted, or, one or more H atoms in Z₀ are independently substituted by F, Cl, Br, or I;
R¹, R², and R³ are independently selected from —H, —OH, —F, —Cl, —Br, —CN, —SCN, —NCS, an alkyl group having 1-10 carbon atoms, an alkoxy group having 1-10 carbon atoms, an alkenyl group having 2-10 carbon atoms, an alkenyloxy group having 2-10 carbon atoms, an alkynyl group having 2-10 carbon atoms, or an alkynyloxy group having 2-10 carbon atoms; one or more end groups in R¹, R², and R³ are not replaced, or, one or more end groups in R¹, R², and R³ are independently replaced by —OH, —CN, or —CF₃; in which one or more —CH₂— groups in R¹, R², and R³ are not replaced, or, one or more —CH₂— groups in R¹, R², and R³ are independently replaced by —O—, —S—, —CO—, —C(O)O—, —OC(O)—, —CF₂O—, —OCF₂—, —CH₂CH₂—, —CH₂O, —OCH₂—, —CH═CH—, or —C≡C—, and heteroatoms therein directly linked to C are not directly linked to each other; and one or more H atoms in R¹, R², and R³ are unsubstituted, or, one or more H atoms in R¹, R², and R³ are independently substituted by F, Cl, Br, or I; and
m is any integer from 0 to 10.

In some embodiments, when one or more end groups in R¹, R², and R³ are independently replaced by —OH, —CN, or —CF₃, one or more end groups in at least one of R¹, R², and R³ are replaced by —OH.

In some embodiments, R^{a} is

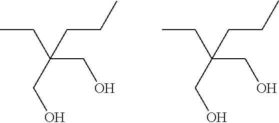

has strong polarity, making is conducive to achieving good adsorption and effective anchoring on the substrates.

In some embodiments, the first compound is selected from at least one of a group consisting of compounds represented by the following formulae I-A to I-Q:

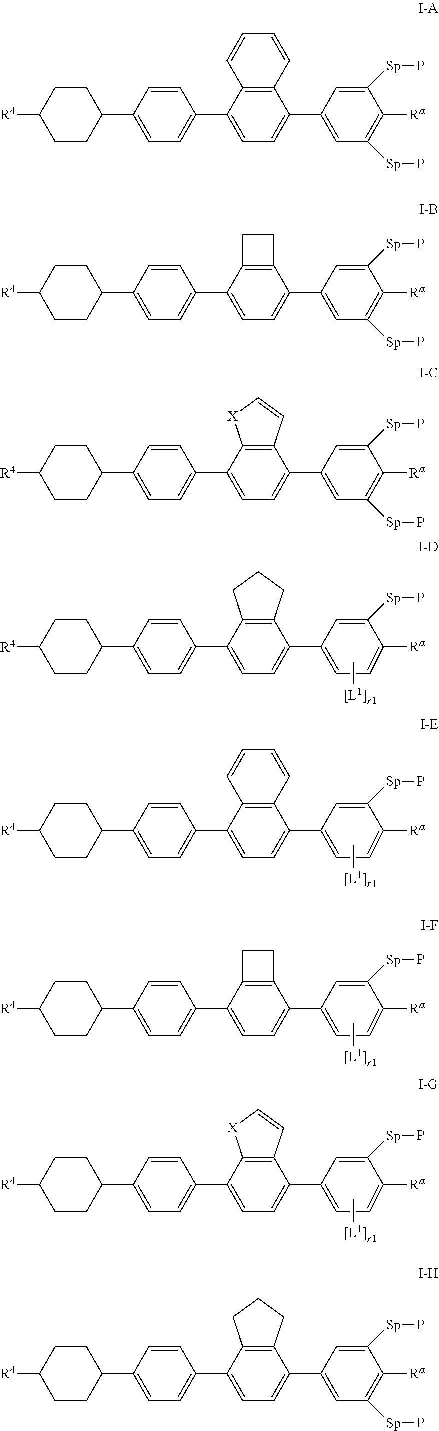

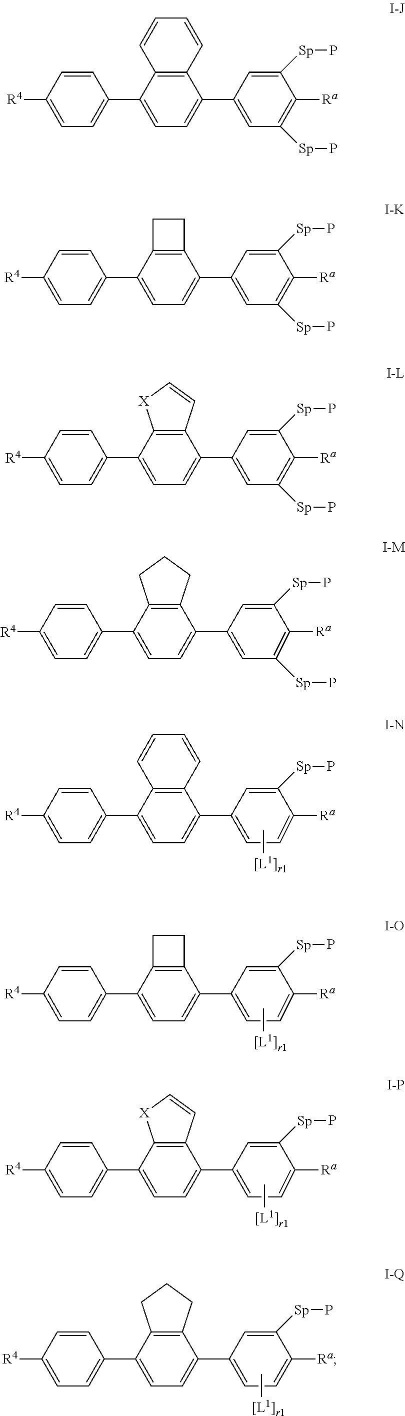

in which R⁴ is independently selected from an alkyl group having 1-15 carbon atoms, an alkoxy group having 1-15 carbon atoms, a cycloalkyl group having 3-15 carbon atoms, an alkenyl group having 2-15 carbon atoms, an alkenyloxy group having 2-15 carbon atoms, an alkynyl group having 2-15 carbon atoms, an alkynyloxy group having 2-15 carbon atoms, or

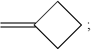

and one or more H atoms in R⁴ are unsubstituted, or, one or more H atoms in R⁴ are independently substituted by F, Cl, Br, or I;
X is independently selected from —S—, —N—, or —O—; and
definitions of L¹, Sp, P, R^{a}, and r1 in formulae I-A to I-Q are the same as definitions of L¹, Sp, P, R^{a}, and r1 in formula I.

In some embodiments, the first compound is selected from at least one of a group consisting of compounds represented by the following formulae IV-1 to IV-32:

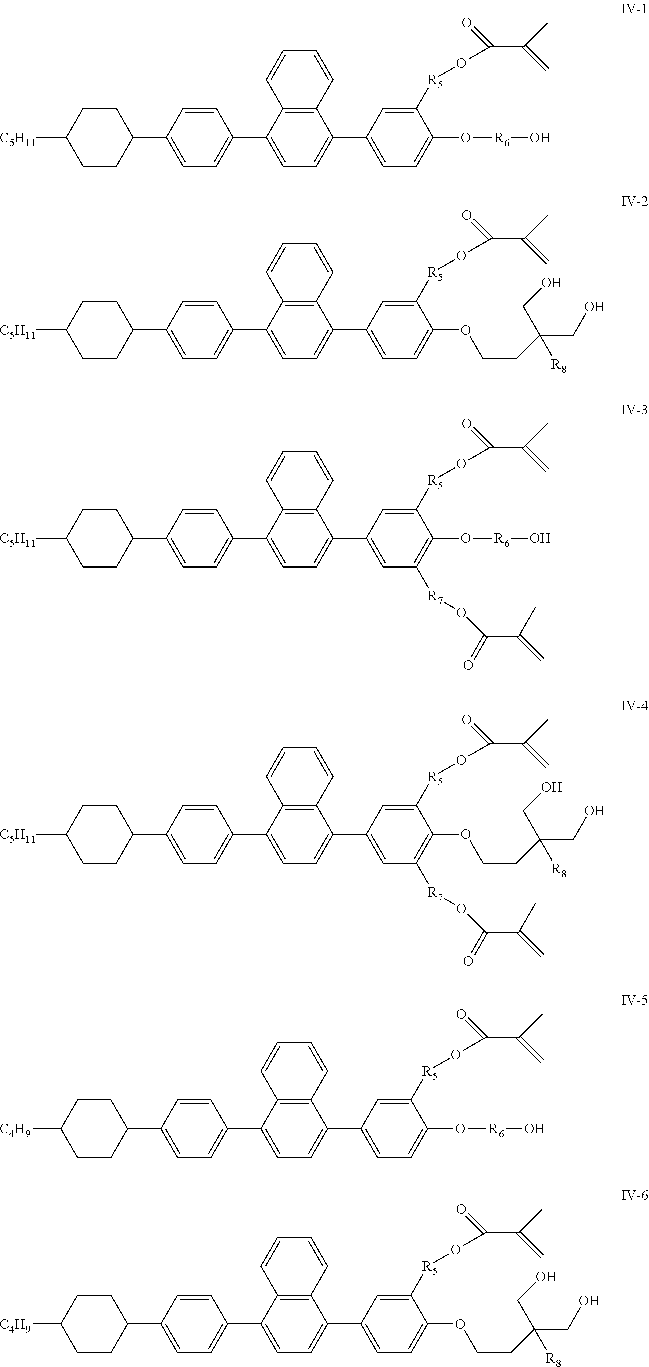

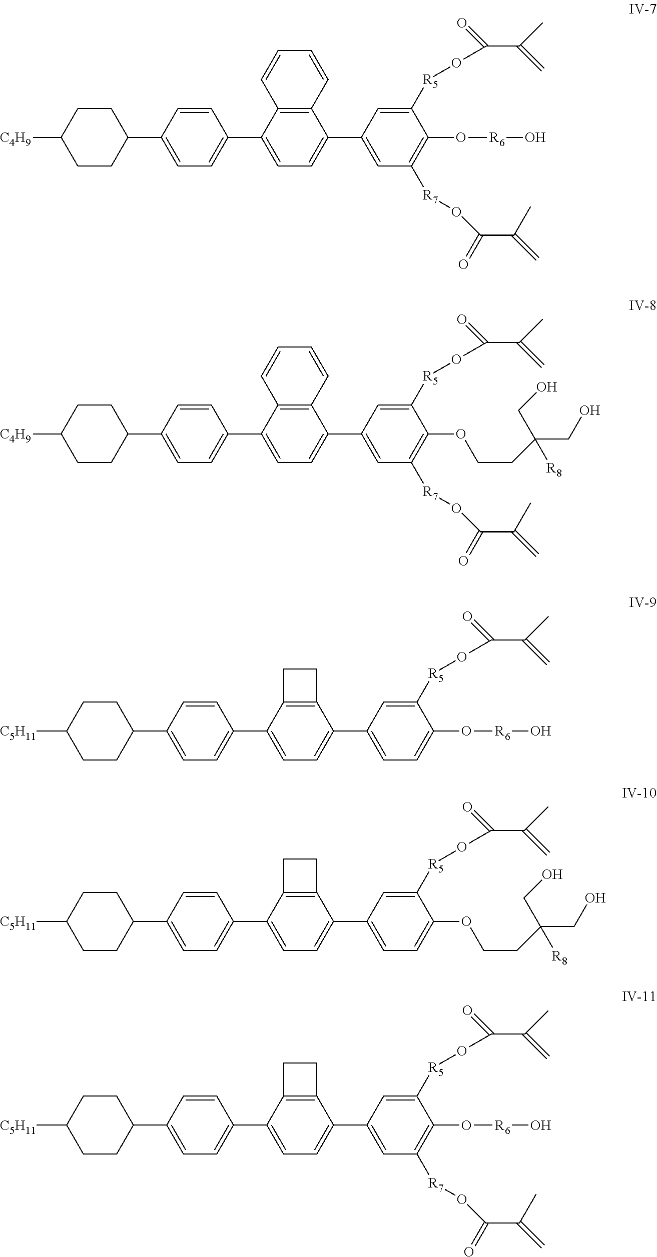

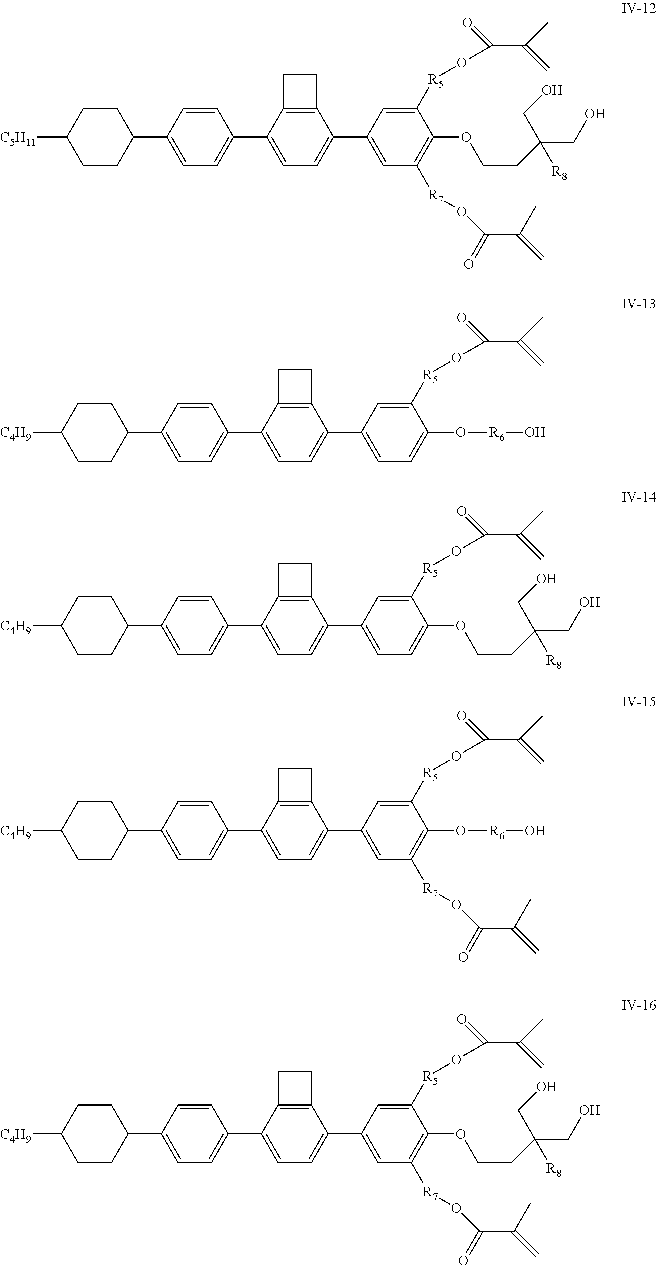

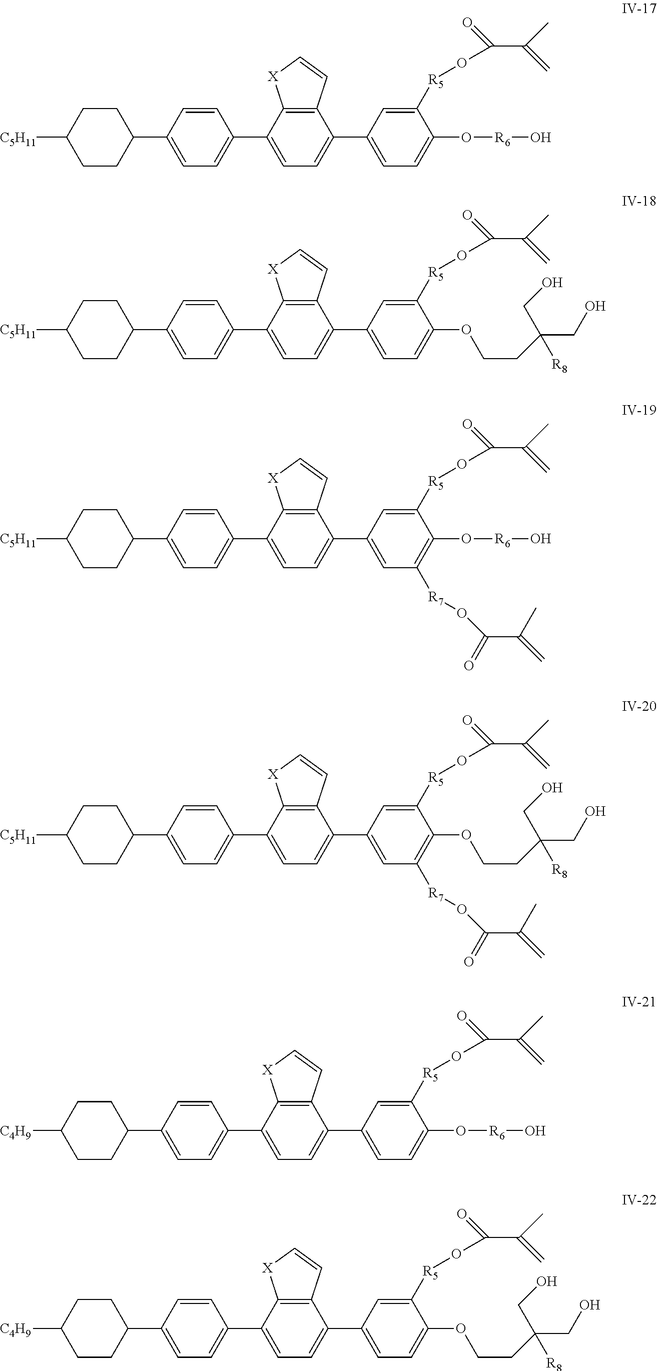

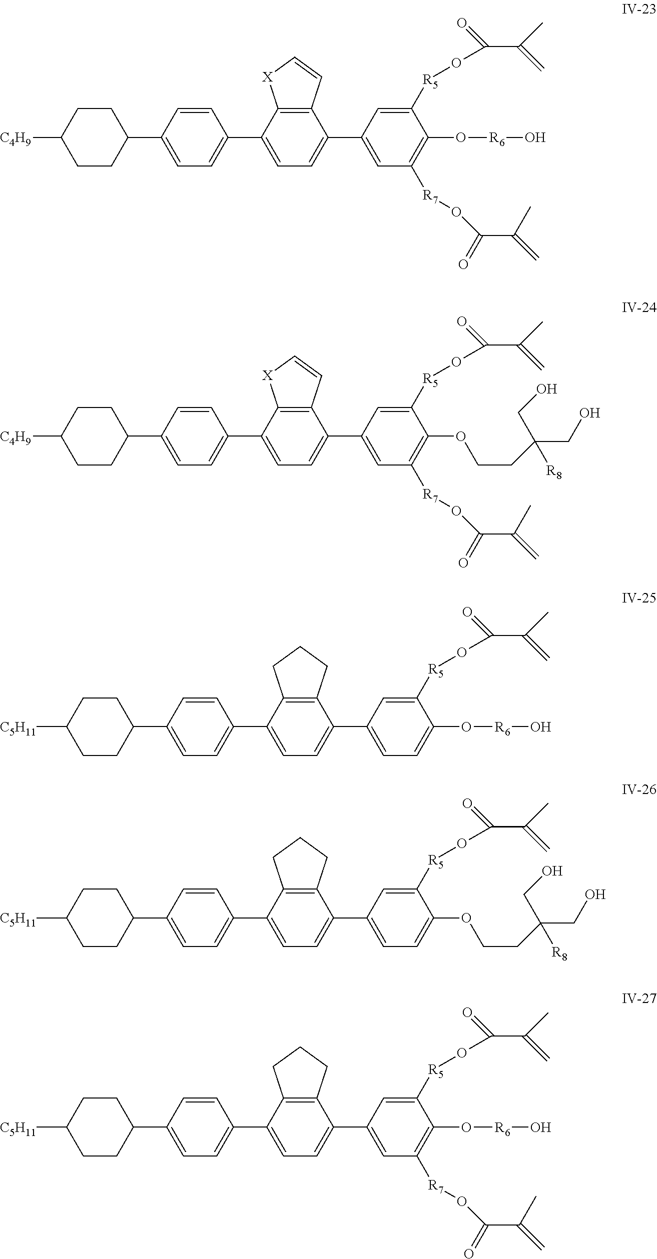

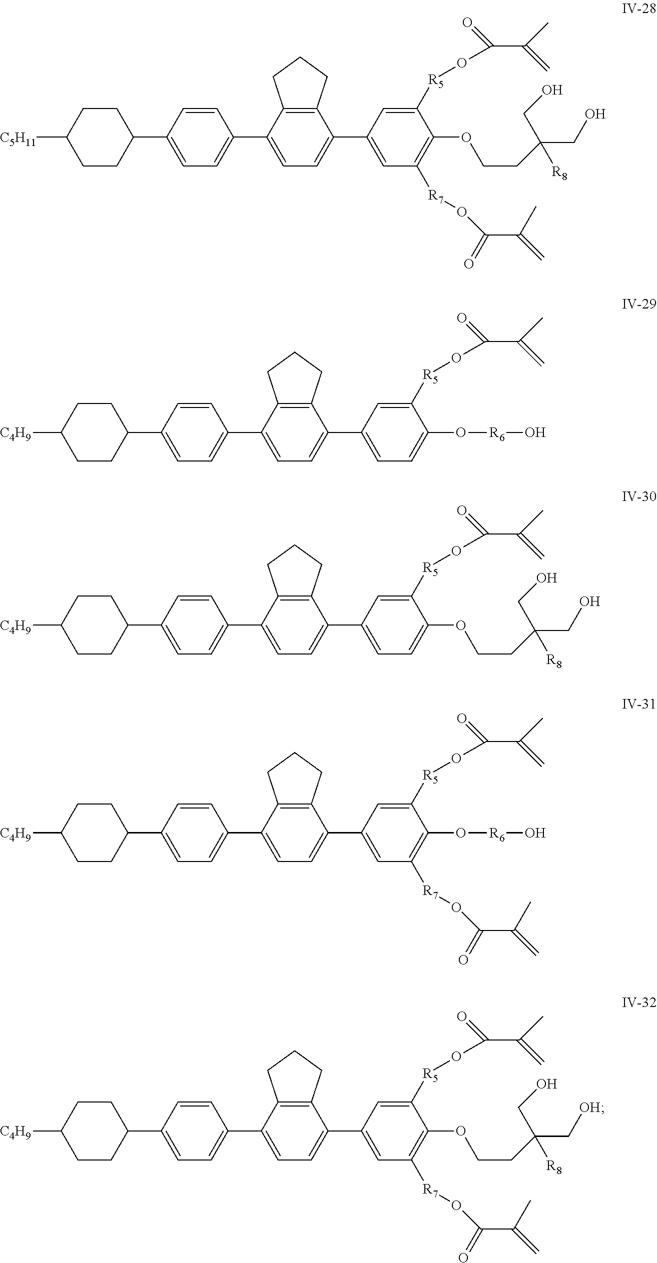

in which R₅, R₆, R₇, and R₈ are independently selected from —H, —OH, —F, —Cl, —Br, —CN, —SCN, —NCS, an alkyl group having 1-10 carbon atoms, an alkoxy group having 1-10 carbon atoms, an alkenyl group having 2-10 carbon atoms, an alkenyloxy group having 2-10 carbon atoms, an alkynyl group having 2-10 carbon atoms, or an alkynyloxy group having 2-10 carbon atoms; one or more —CH₂ groups in R₅, R₆, R₇, and R₈ are not replaced, or, one or more —CH₂ groups in R₅, R₆, R₇, and R₈ are independently replaced by —O—, —S—, —CO—, —C(O)O—, —OC(O)—, —CF₂O—, —OCF₂—, —CH₂CH₂—, —CH₂O—, —OCH₂—, —CH═CH—, or —C≡C—, and heteroatoms therein directly linked to C are not directly linked to each other; and one or more H atoms in R₅, R₆, R₇, and R⁸ are unsubstituted, or, one or more H atoms in R₅, R₆, R₇, and R⁸ are independently substituted by F, Cl, Br, or I; and
X is independently selected from —S—, —N—, or —O—.

In some embodiments, the liquid crystal composition further includes at least one second compound represented by the following formula II:

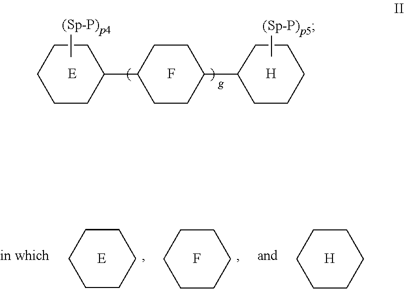

are independently selected from an aromatic ring, a heteroaromatic ring, a fused ring, an aliphatic ring, or an alicyclic heterocyclic ring; and one or more H atoms in

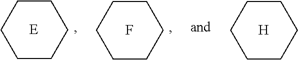

are unsubstituted or independently substituted by L⁰;
g is selected from 0, 1, or 2;
p4 and p5 are independently selected from 1, 2, or 3; and
definitions of P and Sp in formula II are the same as definitions of P and Sp in formula I.

In some embodiments, the second compound is selected from at least one of a group consisting of compounds represented by the following formulae II-A to II-J:

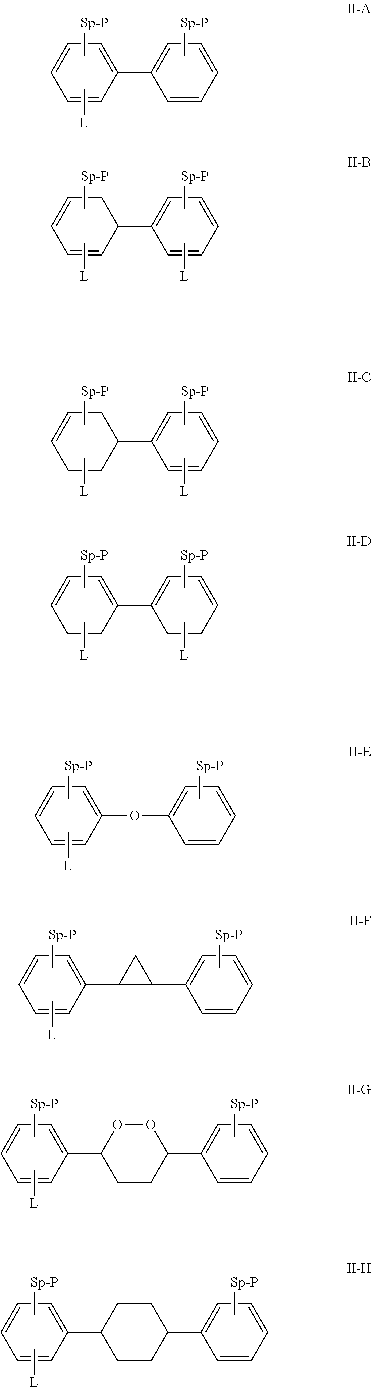

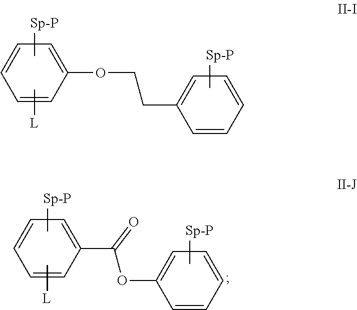

in which L is independently selected from —F, —Cl, —Br, —I, —CN, —NO₂, —NCO, —NCS, —OCN, —SCN, a linear or branched alkyl group having 1-20 carbon atoms, an alkylidene group having 1-20 carbon atoms, an alkoxy group having 1-20 carbon atoms, a cycloalkyl group having 3-20 carbon atoms, an alkenyl group having 2-20 carbon atoms, an alkenylidene group having 2-20 carbon atoms, or an alkynyl group having 2-20 carbon atoms; in which one or more —CH₂— groups not connected together in L are not replaced, or, one or more —CH₂— groups not connected together in L are independently replaced by —O—, —S—, —CO—, —C(O)O—, —OC(O)—, —CF₂O—, —OCF₂—, —CH₂CH₂—, —CH₂O—, —OCH₂—, —CH═CH—, or —C≡C—; and in which one or more H atoms in L are unsubstituted, or, one or more H atoms in L are independently substituted by F, Cl, Br, or I; and
definitions of Sp-P in formulae II-A to II-J are the same as definitions of Sp-P in formulae III to IV.

In some embodiments, the second compound is selected from at least one of a group consisting of compounds represented by the following formulae V-A to V-J:

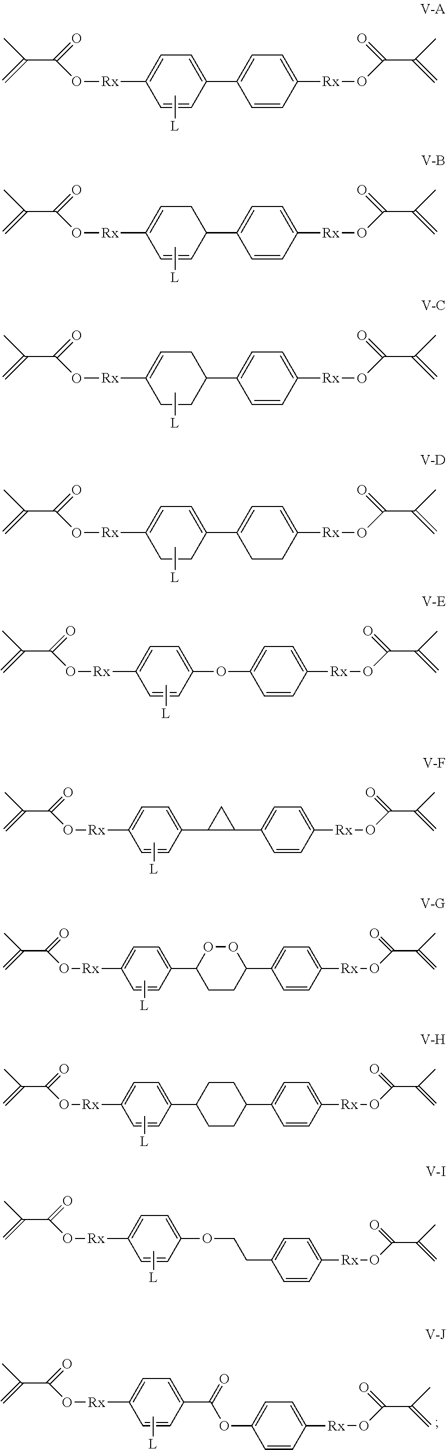

in which Rx is independently selected from an alkylidene group having 1-10 carbon atoms, an alkyleneoxy group having 1-10 carbon atoms, or an alkenylidene group having 2-10 carbon atoms;
one or more —CH₂ groups in Rx are not replaced; or, one or more —CH₂ groups in Rx are independently replaced by —O—, —S—, —CO—, —C(O)O—, —OC(O)—, —CF₂O—, —OCF₂—, —CH₂CH₂—, —CH₂O, —OCH₂—, —CH═CH—, or —C≡C—, and heteroatoms therein directly linked to C are not directly linked to each other; and
one or more H atoms in Rx are unsubstituted, or, one or more H atoms in Rx are independently substituted by F, Cl, Br, or I.

It can be understood that definitions of L in formulae V-A to V-J are the same as definitions of L in formulae II-A to II-J.

In some embodiments, the first compound in the liquid crystal composition ranges from 0.01% to 1.50% by mass on a total mass of the liquid crystal composition, and the second compound in the liquid crystal composition ranges from 0.01% to 1.50% by mass on the total mass of the liquid crystal composition.

In the liquid crystal composition provided in the embodiments of the disclosure, by adding the second compound represented by formula II, the second compound can be polymerized with the first compound under UV light irradiation to form a polymer deposited on surfaces of the substrates, allowing the liquid crystals to form a pre-tilt angle on the surfaces of the substrates, thereby achieving the alignment of the liquid crystals.

In some embodiments, the liquid crystal composition includes both the first compound and the second compound, the first compound can improve properties of the liquid crystal composition in terms of clearing point, viscosity, elastic coefficient, and the like, thereby improving the response time of the display panel using the liquid crystal composition. Moreover, the properties of the liquid crystal composition can be adjusted by adjusting the mass ratio of the first compound to the second compound in the liquid crystal composition.

In some embodiments, rotational viscosity of the liquid crystal composition at temperature of 25° C. is greater than or equal to 40 mPa·s and less than or equal to 100 mPa·s, so that the rotational viscosity of the liquid crystal composition is in a suitable range, improving the rotational speed of the liquid crystal composition, and ensuring that the response time of the display panel using the liquid crystal composition is in a suitable range. For example, the rotational viscosity of the liquid crystal composition at temperature of 25° C. is 45 mPa·s, 50 mPa·s, 52 mPa·s, 55 mPa·s, 60 mPa·s, 65 mPa·s, 70 mPa·s, 75 mPa·s, 80 mPa·s, 85 mPa·s, 90 mPa·s, or the like.

In some embodiments, bending elastic coefficient of the liquid crystal composition is greater than or equal to 10 and less than or equal to 26, for example, 10.5, 10.6, 10.8, 11, 12, 13, 13.1, 13.5, 14, 14.2, 15, 18, 20, 22, 24, 25, or the like. In some embodiments, splaying elastic coefficient of the liquid crystal composition is greater than or equal to 10 and less than or equal to 26, for example, 10.5, 10.6, 11, 12, 13, 13.5, 13.7, 14, 15, 16, 16.1, 16.5, 18, 20, 22, 24, 25, or the like. In some embodiments, both of the bending elastic coefficient and the splaying elastic coefficient of the liquid crystal composition are greater than or equal to 10 and less than or equal to 26, for example, 10.5, 10.6, 11, 12, 13, 13.5, 13.7, 14, 15, 16, 16.1, 16.5, 18, 20, 22, 24, 25, or the like. When at least one of the bending elasticity coefficient and the splaying elasticity coefficient of the liquid crystal composition is in the above range, it is beneficial for the liquid crystal composition to obtain an appropriate average value of elasticity coefficient, effectively improving the response speed of the display panel using the liquid crystal composition, and therefore obtaining a faster response time.

In some embodiments, a dielectric anisotropy of the liquid crystal composition at temperature of 25° C. is greater than or equal to −5 and less than 0, so as to reduce the driving voltage required for driving the display panel using the liquid crystal composition, and therefore reduce the power consumption of the display panel. For example, the dielectric anisotropy of the liquid crystal composition at temperature of 25° C. is −4.8, −4.5, −4.1, −4, −3.5, −3.4, −3.2, −3, −2, −1, or the like.

In some embodiments, a clearing point of the liquid crystal composition ranges from 70° C. to 99° C., so as to avoid a decrease in high temperature resistance of the liquid crystal composition due to too low clearing point of the liquid crystal composition. For example, the clearing point of the liquid crystal composition is 75° C., 77° C., 79° C., 80° C., 82° C., 84° C., 85° C., 88° C., 90° C., 92° C., 95° C., 97° C., 99° C., or the like.

In some embodiments, the contrast ratio of the display panel using the liquid crystal composition ranges from 5800 to 7000, for example, 5800, 5900, 6000, 6100, 6200, 6300, 6400, 6500, 6600, 6700, 6800, 6900, 7000, or the like. In contrast, the display panels in the prior art have a contrast ratio of 5800 or less.

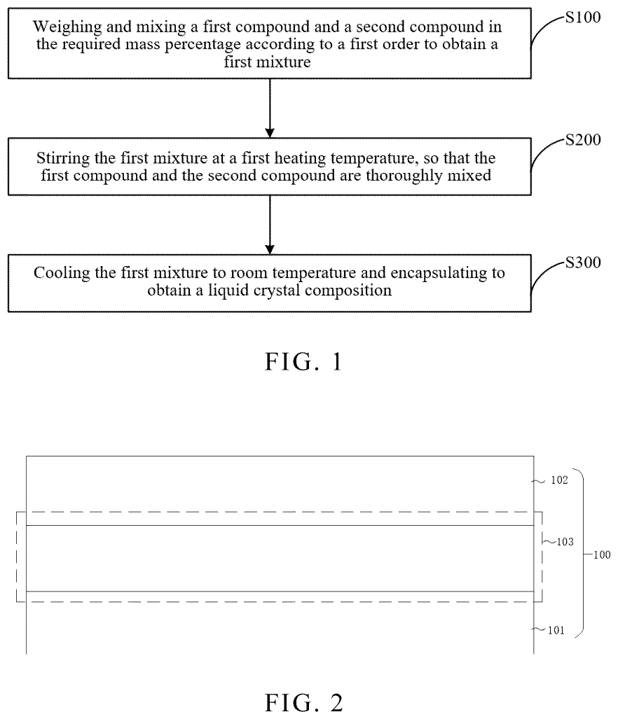

Referring to FIG. 1, some embodiments of the disclosure provide a method for preparing the liquid crystal composition as described in any one of the above-mentioned embodiments, including the following steps S100, S200, and S300.

In step S100, a first mixture is obtained by weighing and mixing the first compound and the second compound in the required mass percentage according to a first order. The first order is that the compounds, for example, the first compound and the second compound, are weighed and mixed sequentially in an order of melting points from low to high.

In some embodiments, the liquid crystal composition further includes liquid crystal materials, and therefore the first mixture in step S100 includes the liquid crystal materials, the first compound, and the second compound.

In step S200, the first mixture is stirred at a first heating temperature, so that the first compound and the second compound are thoroughly mixed. In some embodiments, the first heating temperature ranges from 60° C. to 100° C.

In step S300, the first mixture is cooled to room temperature and encapsulated to obtain the liquid crystal composition.

Referring to FIG. 2, some embodiments of the disclosure further provide a display panel 100, which includes a first substrate 101, a second substrate 102, and a liquid crystal layer 103. The second substrate 102 is disposed on the first substrate 101, and the liquid crystal layer 103 is disposed between the first substrate 101 and the second substrate 102. The liquid crystal layer 103 is prepared from the liquid crystal composition as described in any one of the above-mentioned embodiments.

When voltage applied on a vertical alignment (VA) display is 0 V, the arrangement direction of liquid crystals of the VA display is perpendicular to the glass substrates of the VA display, and thus incident light perpendicular to the glass substrates cannot pass through, showing a good dark state effect. Therefore, the VA display has a negative dielectric anisotropy and a good contrast ratio.

In the display panel 100 provided in the embodiments of the disclosure, the liquid crystal layer 103 is prepared from the liquid crystal composition as described in any one of the above-mentioned embodiments. Since the first compound of the liquid crystal composition contains a large number of polar groups, the liquid crystal composition has a larger negative dielectric anisotropy, which is conducive to improving the contrast ratio of the display panel 100. Therefore, the liquid crystal composition provided in the embodiments of the disclosure is suitable for the use in the VA display.

The following will provide specific Examples to illustrate the disclosure. It can be understood that the specific embodiments described herein are only for illustration and explanation of the disclosure and are not intended to limit the disclosure. In addition, unless otherwise specified, the liquid crystal materials in the following Examples are all commercially available products.

Exemplary combinations of the above-mentioned compounds in the liquid crystal compositions provided in Examples 1-4 and Comparative Examples 1-4 are shown in the following Tables 1-8. In the following property parameters of the liquid crystal compositions provided in Examples 1-4 and Comparative Examples 1-4, unless otherwise specified, the amount by mass was calculated on a total mass of the liquid crystal composition, Tni (unit: ° C.) indicates a clearing point of the liquid crystal composition, Δn indicates an optical anisotropy of the liquid crystal composition at temperature of 25° C., nₑ indicates refractive index of extraordinary ray, γ1 (unit: mPa·s) indicates rotational viscosity of the liquid crystal composition at temperature of 25° C., Δε indicates a dielectric anisotropy of the liquid crystal composition at temperature of 25° C., ε⊥ indicates a dielectric constant of the liquid crystal composition in a direction perpendicular to a long axis of liquid crystals, K₁₁ indicates a splaying elastic coefficient of the liquid crystal composition, and K₃₃ indicates a bending elastic coefficient of the liquid crystal composition.

### Example 1

The compounds used in the liquid crystal composition provided in Example 1 are shown in Table 1 as to their structures and amounts by mass. In the liquid crystal composition provided in Example 1, Compounds 1-10 are liquid crystal materials, and Compound 11 is the first compound represented by formula I. Based on the total mass of the liquid crystal composition, the Compounds 1-10 in the liquid crystal composition are 99.9% by mass, and the Compound 11 in the liquid crystal composition is 0.1% by mass.

The liquid crystal composition of Example 1 has the following property parameters: Tni of 91° C., γ₁ of 94 mPa·s, Δn of 0.108, nₑ of 1.591, Δε of −3.2, ε⊥ of 6.5, K₁₁ of 14.8, and K₃₃ of 15.9. There is no crystal precipitation when the liquid crystal composition is stayed at −20° C. for 480 hours.

### Example 2

The compounds used in the liquid crystal composition provided in Example 2 are shown in Table 2 as to their structures and amounts by mass. In the liquid crystal composition provided in Example 2, Compounds 1-10 are liquid crystal materials, and Compound 11 is the first compound represented by formula I. Based on the total mass of the liquid crystal composition, the Compounds 1-10 in the liquid crystal composition are 99.6% by mass, and the Compound 11 in the liquid crystal composition is 0.4% by mass.

The liquid crystal composition of Example 2 has the following property parameters: Tni of 76° C., γ₁ of 74 mPa·s, Δn of 0.120, nₑ of 1.607, Δε of −3.2, ε⊥ of 6.5, K₁₁ of 14.4, and K₃₃ of 15.2. There is no crystal precipitation when the liquid crystal composition is stayed at −20° C. for 480 hours.

### Example 3

The compounds used in the liquid crystal composition provided in Example 3 are shown in Table 3 as to their structures and amounts by mass. In the liquid crystal composition provided in Example 3, Compounds 1-11 are liquid crystal materials, and Compound 12 is the first compound represented by formula I. Based on the total mass of the liquid crystal composition, the Compounds 1-11 in the liquid crystal composition are 99.6% by mass, and the Compound 12 in the liquid crystal composition is 0.4% by mass.

The liquid crystal composition of Example 3 has the following property parameters: Tni of 90° C., γ₁ of 103 mPa·s, Δn of 0.111, nₑ of 1.596, Δε of −3.4, ε⊥ of 7.0, K₁₁ of 17.8, and K₃₃ of 19.1. There is no crystal precipitation when the liquid crystal composition is stayed at −20° C. for 480 hours.

### Example 4

The compounds used in the liquid crystal composition provided in Example 4 are shown in Table 4 as to their structures and amounts by mass. In the liquid crystal composition provided in Example 4, Compounds 1-10 are liquid crystal materials, Compound 11 is the second compound represented by formula II, and Compound 12 is the first compound represented by formula L. Based on the total mass of the liquid crystal composition, the Compounds 1-10 in the liquid crystal composition are 99.2% by mass, the Compound 11 in the liquid crystal composition is 0.4% by mass, and the Compound 12 in the liquid crystal composition is 0.4% by mass.

The liquid crystal composition of Example 4 has the following property parameters: Tni of 84° C., γ₁ of 100 mPa·s, Δn of 0.117, nₑ of 1.607, Δε of −3.6, ε⊥ of 7.2, K₁₁ of 15.0, and K₃₃ of 16.4. There is no crystal precipitation when the liquid crystal composition is stayed at −20° C. for 480 hours.

### Comparative Example 1

The difference between Comparative Example 1 and Example 1 is in that the liquid crystal composition provided in Comparative Example 1 does not add the first compound represented by formula I, that is, Compounds 1-10 in the liquid crystal composition of Comparative Example 1 are all liquid crystal materials. The compounds used in the liquid crystal composition provided in Comparative Example 1 are shown in Table 5 as to their structures and amounts by mass.

The liquid crystal composition of Comparative Example 1 has the following property parameters: Tni of 91° C., γ₁ of 93 mPa·s, Δn of 0.108, nₑ of 1.591, Δε of −3.2, ε⊥ of 6.5, K₁₁ of 14.7, and K₃₃ of 15.9. There is no crystal precipitation when the liquid crystal composition is stayed at −20° C. for 480 hours.

### Comparative Example 2

The difference between Comparative Example 2 and Example 2 is in that the liquid crystal composition provided in Comparative Example 2 does not add the first compound represented by formula I, that is, Compounds 1-10 in the liquid crystal composition of Comparative Example 2 are all liquid crystal materials. The compounds used in the liquid crystal composition provided in Comparative Example 2 are shown in Table 6 as to their structures and amounts by mass.

TABLE 6
Compounds of liquid crystal composition

| | | Amount |
|---|---|---|
| | | by mass |
| Compound | Structure | (%) |
| Compound 1 | 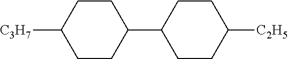 | 14 |
| Compound 2 | 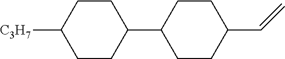 | 7 |
| Compound 3 | 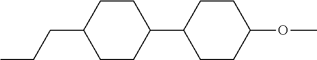 [SMILES: CCCC1CCC(C2CCC(OC)CC2)CC1] | 12 |
| Compound 4 | 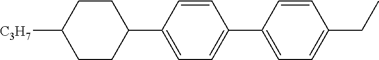 | 8 |
| Compound 5 | 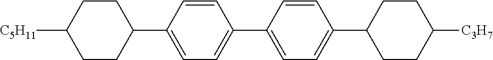 | 3 |
| Compound 6 | 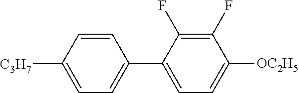 | 15 |
| Compound 7 | 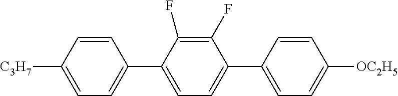 | 9 |
| Compound 8 | 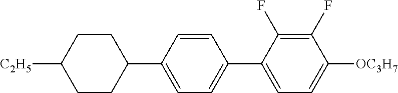 | 7 |
| Compound 9 | 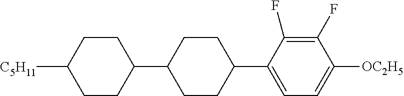 | 14 |
| Compound 10 | 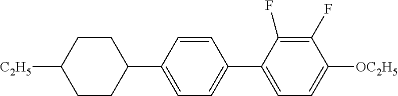 [SMILES: CCOc1ccc(-c2ccc(C3CCC(CC)CC3)cc2)c(F)c1F] | 11 |

The liquid crystal composition of Comparative Example 2 has the following property parameters: Tni of 76° C., γ₁ of 73 mPa·s, Δn of 0.120, nₑ of 1.607, Δε of −3.2, ε⊥ of 6.5, K₁₁ of 14.3, and K₃₃ of 15.2. There is no crystal precipitation when the liquid crystal composition is stayed at −20° C. for 480 hours.

### Comparative Example 3

The difference between Comparative Example 3 and Example 3 is in that the liquid crystal composition provided in Comparative Example 3 does not add the first compound represented by formula I, that is, Compounds 1-11 in the liquid crystal composition of Comparative Example 3 are all liquid crystal materials. The compounds used in the liquid crystal composition provided in Comparative Example 3 are shown in Table 7 as to their structures and amounts by mass.

The liquid crystal composition of Comparative Example 3 has the following property parameters: Tni of 90° C., γ₁ of 102 mPa·s, Δn of 0.111, nₑ of 1.596, Δε of −3.4, ε⊥ of 7.0, K₁₁ of 17.7, and K₃₃ of 19.1. There is no crystal precipitation when the liquid crystal composition is stayed at −20° C. for 480 hours.

### Comparative Example 4

The difference between Comparative Example 4 and Example 4 is in that the liquid crystal composition provided in Comparative Example 4 does not add the first compound represented by formula I and the second compound represented by formula II, that is, Compounds 1-10 in the liquid crystal composition of Comparative Example 4 are all liquid crystal materials. The compounds used in the liquid crystal composition provided in Comparative Example 4 are shown in Table 8 as to their structures and amounts by mass.

TABLE 8
Compounds of liquid crystal composition

| | | Amount by mass |
|---|---|---|
| Compound | Structure | (%) |
| Compound 1 | 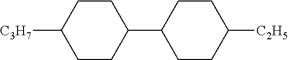 | 13 |
| Compound 2 | 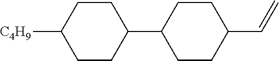 | 10 |
| Compound 3 | 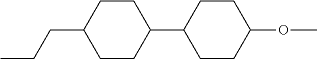 [SMILES: CCCC1CCC(C2CCC(OC)CC2)CC1] | 10 |
| Compound 4 | 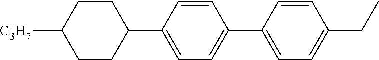 | 10 |
| Compound 5 | 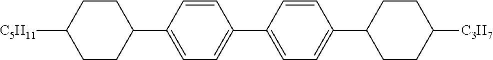 | 5 |
| Compound 6 | 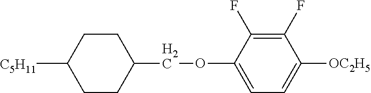 | 8 |
| Compound 7 | 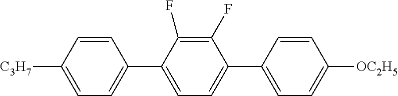 | 12 |
| Compound 8 | 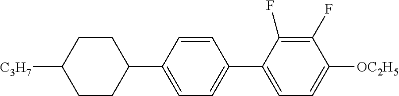 | 15 |
| Compound 9 | 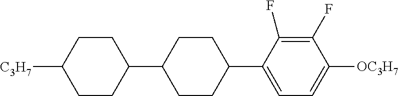 | 13 |
| Compound 10 | 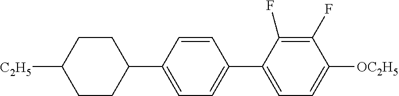 [SMILES: CCOc1ccc(-c2ccc(C3CCC(CC)CC3)cc2)c(F)c1F] | 7 |

The liquid crystal composition of Comparative Example 4 has the following property parameters: Tni of 84° C., γ₁ of 98 mPa·s, Δn of 0.117, nₑ of 1.607, Δε of −3.6, ε⊥ of 7.2, K₁₁ of 14.8, and K₃₃ of 16.4. There is no crystal precipitation when the liquid crystal composition is stayed at −20° C. for 480 hours.

As can be seen from Tables 1-8, compared with the Comparative Examples 1-4, the liquid crystal compositions provided in Examples 1-4 add the first compound or a combination of the first compound and the second compound, since the benzene ring of the main chain of the formula I is connected to a multi-membered ring with large steric hindrance, the multi-membered ring can serve as electron donor to increase the electron cloud density of the main chain of the formula I, reducing the light energy threshold required for the alignment of liquid crystals, and achieving self-alignment of the liquid crystals without the process for preparing the PI alignment layers. Moreover, after the self-alignment of the liquid crystals is completed, the addition of the first compound also stabilizes the ion concentration of the liquid crystal system, thereby improving the reliability of substrates. In addition, since the first compound contains a large number of polar groups, the liquid crystal composition has a larger negative dielectric anisotropy, which is conducive to improving the contrast ratio of a display panel using the liquid crystal composition. In contrast, the liquid crystal compositions provided in the Comparative Examples 1-4 do not add the first compound, and thus, in order to achieve the alignment of liquid crystals, the process for preparing the PI alignment layers is required.

Moreover, the liquid crystal composition provided in Example 4 adds the second compound represented by formula II, the second compound can be polymerized with the first compound under UV light irradiation to form a polymer deposited on surfaces of the substrates, allowing the liquid crystals to form a pre-tilt angle on the surfaces of the substrates, thereby achieving the alignment of the liquid crystals.

Furthermore, the liquid crystal composition provided in Example 1 has the clearing point (Tni) greater than 90° C., and therefore, the liquid crystal composition has a wide range of operating temperature and a high upper limit of operating temperature. In addition, the liquid crystal composition also has a larger negative dielectric anisotropy (Δε of −3.4) at temperature of 25° C. and a lower driving voltage, achieving faster response time and lower power consumption of the display panel using the liquid crystal composition. Moreover, the liquid crystal composition provided in Example 1 has smaller rotational viscosity (71), larger spaying elasticity coefficient (K₁₁), and larger bending elasticity coefficient (K₃₃), which are conducive to improving the response speed of the display panel using the liquid crystal composition. This is because the lower the rotational viscosity, the faster the response time, and the larger the elastic coefficient, indicating that the liquid crystals have a stronger ability to restore their original arrangement and to achieve a faster response time.

In addition, the display panel using the liquid crystal composition provided in Example 1 has a larger contrast ratio reaching more than 6800 and a larger negative dielectric anisotropy, and the larger negative dielectric anisotropy is conducive to improving the contrast ratio of the display panel. Moreover, the first compound of the liquid crystal composition contains a large number of polar groups, so that the liquid crystal composition has a larger dielectric anisotropy (Δε), which improves the contrast ratio of the display panel using the liquid crystal composition.

The first compound and the second compound provided in the embodiments of the disclosure can be used as self-alignment additives. As can be seen from Tables 2-4 and 6-8, compared with Comparative Examples 2-4, the liquid crystal compositions provided in Examples 2-4 add the self-alignment additives. By mixing different self-alignment additives with liquid crystal materials to form different liquid crystal compositions, property parameters of the liquid crystal composition, such as rotational viscosity, clearing point, negative dielectric anisotropy, bending elastic coefficient, and the like, can be improved. In addition, as can be seen from the property parameters of the liquid crystal composition provided in Example 4, self-alignment additives represented by formula I and formula II can be used in combination.

The self-alignment additives (the first compound and the second compound) of the liquid crystal compositions provided in Examples 1 to 4 were tested through high-resolution mass spectrometry. The high-resolution mass spectrometry result of the first compound of Example 1 was as follows: [M+H]⁺ of 697.4; the high-resolution mass spectrometry result of the first compound of Example 2 was as follows: [M+H]⁺ of 803.4; the high-resolution mass spectrometry result of the first compound of Example 3 was as follows: [M+H]⁺ of 835.5; and the high-resolution mass spectrometry result of the first compound of Example 4 was as follows: [M+H]⁺ of 783.5, and the high-resolution mass spectrometry result of the second compound of Example 4 was as follows: [M+H]⁺ of 355.1.

The above provides a detailed description to the liquid crystal composition and the display panel provided in the embodiments of the disclosure. Specific embodiments are applied in this context to explain the principles and implementation methods of the disclosure. The explanation of the above-mentioned embodiments is only used to help understand the technical solutions and core ideas of the disclosure. For ordinary skilled in the art, there may be changes in the specific implementation methods and scopes based on the ideas of the disclosure. Therefore, the contents of the disclosure should not be understood as limitations on the disclosure.

What is claimed is:

1. A liquid crystal composition comprising at least one first compound represented by the following formula I: 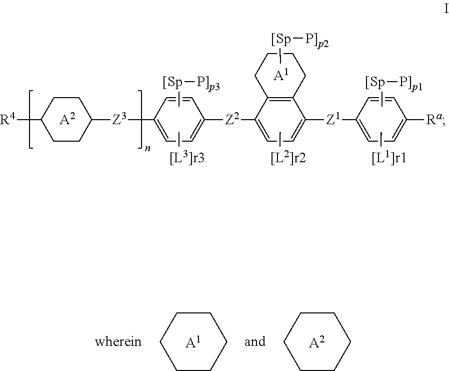
are independently selected from an aromatic ring, a heteroaromatic ring, a fused ring, an aliphatic ring, or an alicyclic heterocyclic ring, wherein one or more H atoms in 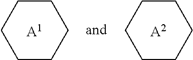
are unsubstituted or independently substituted by L⁰;
Z¹, Z², and Z³ are independently selected from a single bond, —O—, —S—, —CO—, —C(O)O—, —OC(O)—, —CF₂O—, —OCF₂—, —CH₂CH₂—, —CH₂O—, —OCH₂—, —CH═CH—, —C≡C—, an alkylidene group having 1-10 carbon atoms, an alkenylidene group having 2-10 carbon atoms, or an alkynyl group having 2-10 carbon atoms; wherein one or more —CH₂— groups not connected together in Z¹, Z², and Z³ are not replaced, or, one or more —CH₂— groups not connected together in Z¹, Z², and Z³ are independently replaced by —O—, —S—, —CO—, —C(O)O—, —OC(O)—, —CF₂O—, —OCF₂—, —CH₂CH₂—, —CH₂O—, —OCH₂—, —CH═CH—, or —C≡C—; and wherein one or more H atoms in Z¹, Z², and Z³ are unsubstituted, or, one or more H atoms in Z¹, Z², and Z³ are independently substituted by F, Cl, Br, or I;
L⁰, L¹, L², and L³ are independently selected from —F, —Cl, —Br, —I, —CN, —NO₂, —NCO, —NCS, —OCN, —SCN, a linear or branched alkyl group having 1-5 carbon atoms, or an alkoxy group having 1-5 carbon atoms; wherein one or more H atoms in L⁰, L¹, L², and L³ are unsubstituted, or, one or more H atoms in L⁰, L¹, L², and L³ are independently substituted by F or Cl;
P is a polymerizable group;
Sp is independently selected from a spacer group or a single bond;
R⁴ is selected from an alkyl group having 1-15 carbon atoms, an alkoxy group having 1-15 carbon atoms, a cycloalkyl group having 3-15 carbon atoms, an alkenyl group having 2-15 carbon atoms, an alkenyloxy group having 2-15 carbon atoms, an alkynyl group having 2-15 carbon atoms, an alkynyloxy group having 2-15 carbon atoms, or 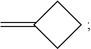
wherein one or more —CH₂— groups in R⁴ are not replaced, or, one or more —CH₂— groups in R⁴ are independently replaced by —CH═CH—, —C≡C—, —CF₂O—, 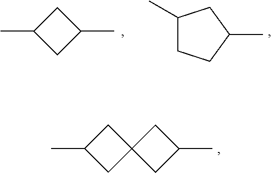
—CO—, —C(O)O—, —OC(O)—, or —O—; and wherein one or more H atoms in R⁴ are unsubstituted, or, one or more H atoms in R⁴ are independently substituted by F, Cl, Br, or I;
R^{a} is independently selected from a group capable of anchoring to a substrate;
n is selected from 0, 1, or 2;
p1, p2, and p3 are independently selected from 1, 2, or 3; and
r1, r2, and r3 are independently selected from 0, 1, 2, or 3.

2. The liquid crystal composition of claim 1, wherein Sp-P in formula I is represented by the following formula III or formula IV, wherein the spacer group is represented by —Z⁴— in formula III and formula IV, and the polymerizable group is represented by 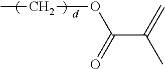
in formula III and 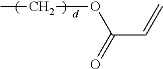
in formula IV; 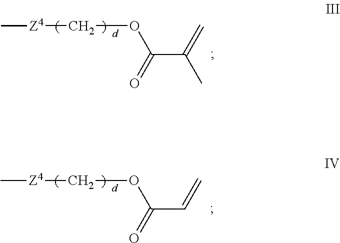
wherein Z⁴ is independently selected from a single bond, —O—, —S—, —CO—, —C(O)O—, —OC(O)—, —CF₂O—, —OCF₂—, —CH₂CH₂—, —CH₂O—, —OCH₂—, —CH═CH—, —C≡C—, an alkylidene group having 1-10 carbon atoms, an alkenylidene group having 2-10 carbon atoms, or an alkynyl group having 2-10 carbon atoms; wherein one or more —CH₂— groups not connected together in Z⁴ are not replaced, or, one or more —CH₂— groups not connected together in Z⁴ are independently replaced by —O—, —S—, —CO—, —C(O)O—, —OC(O)—, —CF₂O—, —OCF₂—, —CH₂CH₂—, —CH₂O—, —OCH₂—, —CH═CH—, —C≡C—; and wherein one or more H atoms in Z⁴ are unsubstituted, or, one or more H atoms in Z⁴ are independently substituted by F, Cl, Br, or I; and
d is any integer from 0 to 10.

3. The liquid crystal composition of claim 1, wherein R^{a} is represented by the following formula V: 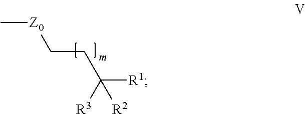
wherein Z₀ is selected from a single bond, —O—, —S—, —CO—, —C(O)O—, —OC(O)—, —CF₂O—, —OCF₂—, —CH₂CH₂—, —CH₂O—, —OCH₂—, —CH═CH—, —C≡C—, an alkylidene group having 1-10 carbon atoms, an alkenylidene group having 2-10 carbon atoms, or an alkynyl group having 2-10 carbon atoms; wherein one or more —CH₂— groups not connected together in Z₀ are not replaced, or, one or more —CH₂— groups not connected together in Z₀ are independently replaced by —O—, —S—, —CO—, —C(O)O—, —OC(O)—, —CF₂O—, —OCF₂—, —CH₂CH₂—, —CH₂O—, —OCH₂—, —CH═CH—, or —C≡C—; and wherein one or more H atoms in Z₀ are unsubstituted, or, one or more H atoms in Z₀ are independently substituted by F, Cl, Br, or I;
R¹, R², and R³ are independently selected from —H, —OH, —F, —Cl, —Br, —CN, —SCN, —NCS, an alkyl group having 1-10 carbon atoms, an alkoxy group having 1-10 carbon atoms, an alkenyl group having 2-10 carbon atoms, an alkenyloxy group having 2-10 carbon atoms, an alkynyl group having 2-10 carbon atoms, or an alkynyloxy group having 2-10 carbon atoms; wherein one or more end groups in R¹, R², and R³ are not replaced, or, one or more end groups in R¹, R², and R³ are independently replaced by —OH, —CN, or —CF₃; wherein one or more —CH₂— groups in R¹, R², and R³ are not replaced, or, one or more —CH₂— groups in R¹, R², and R³ are independently replaced by —O—, —S—, —CO—, —C(O)O—, —OC(O)—, —CF₂O—, —OCF₂—, —CH₂CH₂—, —CH₂O, —OCH₂—, —CH═CH—, or —C≡C—, and heteroatoms therein directly linked to C are not directly linked to each other; and wherein one or more H atoms in R¹, R², and R³ are unsubstituted, or, one or more H atoms in R¹, R², and R³ are independently substituted by F, Cl, Br, or I; and
m is any integer from 0 to 10.

4. The liquid crystal composition of claim 1, wherein the first compound is selected from at least one of a group consisting of compounds represented by the following formulae I-A to I-Q: 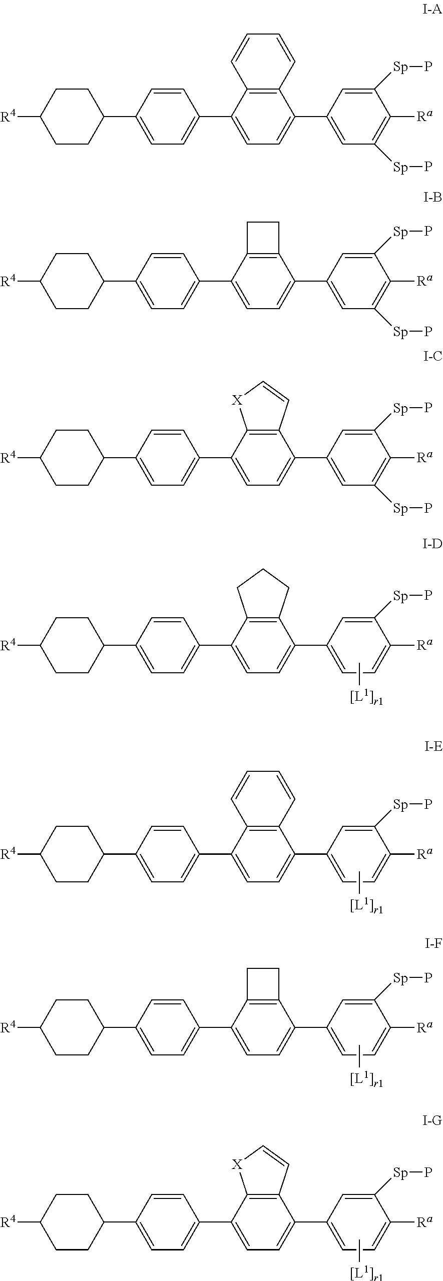 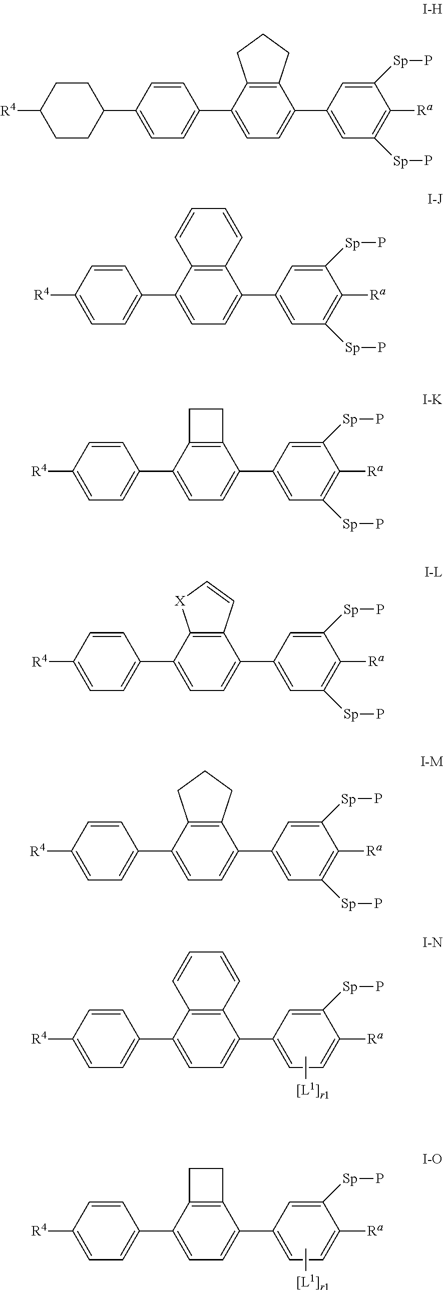 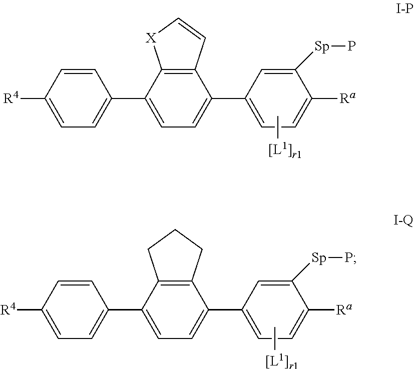
wherein R⁴ is independently selected from an alkyl group having 1-15 carbon atoms, an alkoxy group having 1-15 carbon atoms, a cycloalkyl group having 3-15 carbon atoms, an alkenyl group having 2-15 carbon atoms, an alkenyloxy group having 2-15 carbon atoms, an alkynyl group having 2-15 carbon atoms, an alkynyloxy group having 2-15 carbon atoms, or 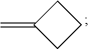
wherein one or more H atoms in R⁴ are unsubstituted, or, one or more H atoms in R⁴ are independently substituted by F, Cl, Br, or I;
X is independently selected from —S—, —N—, or —O—; and
definitions of L¹, Sp, P, R^{a}, and r1 in formulae I-A to I-Q are the same as definitions of L¹, Sp, P, R^{a}, and r1 in formula I.

5. The liquid crystal composition of claim 1, wherein the first compound is selected from at least one of a group consisting of compounds represented by the following formulae IV-1 to IV-32: 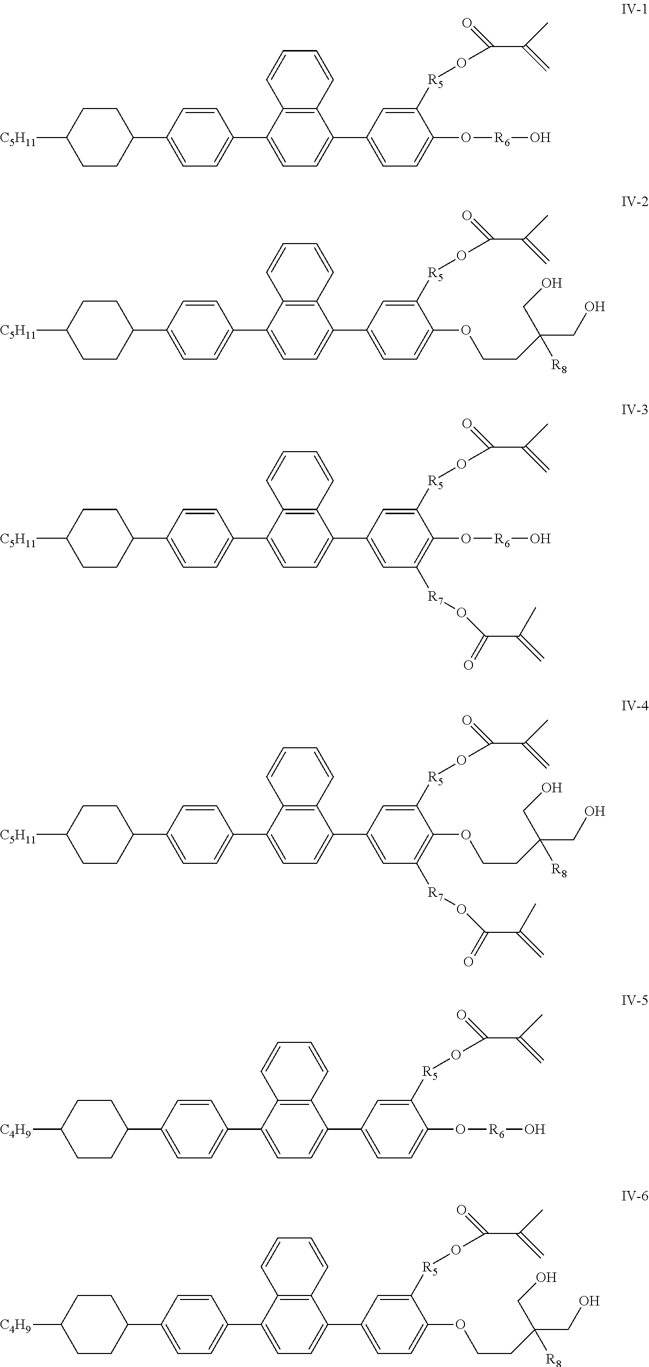 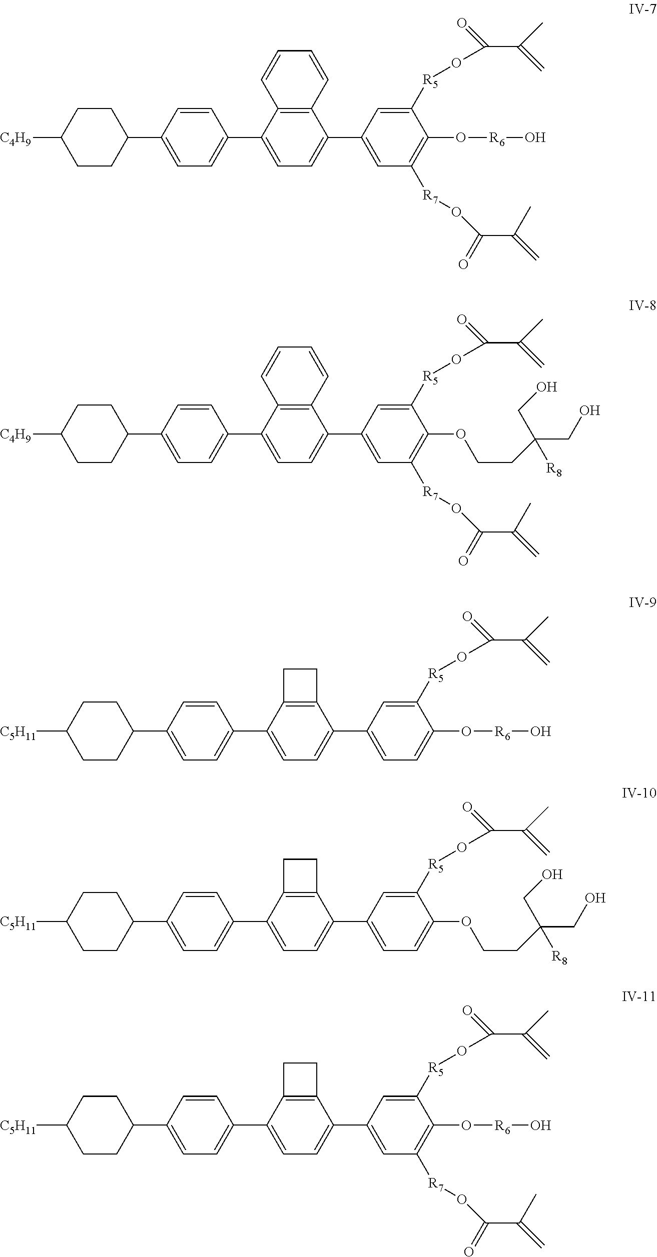 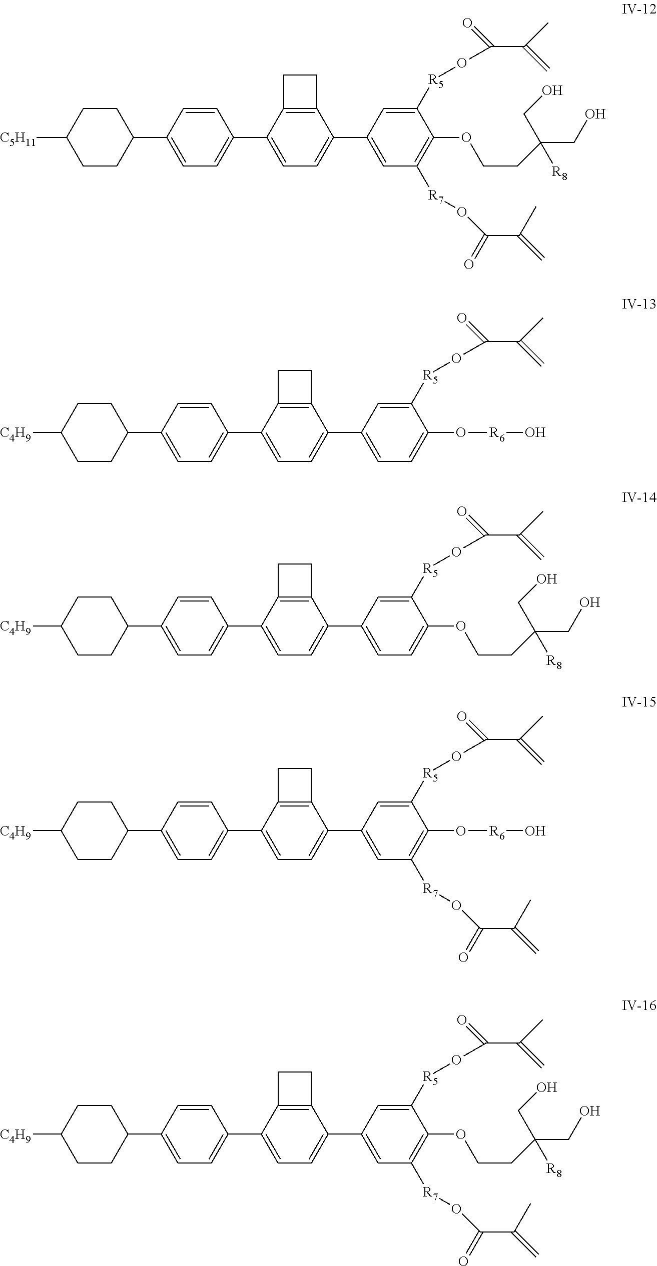 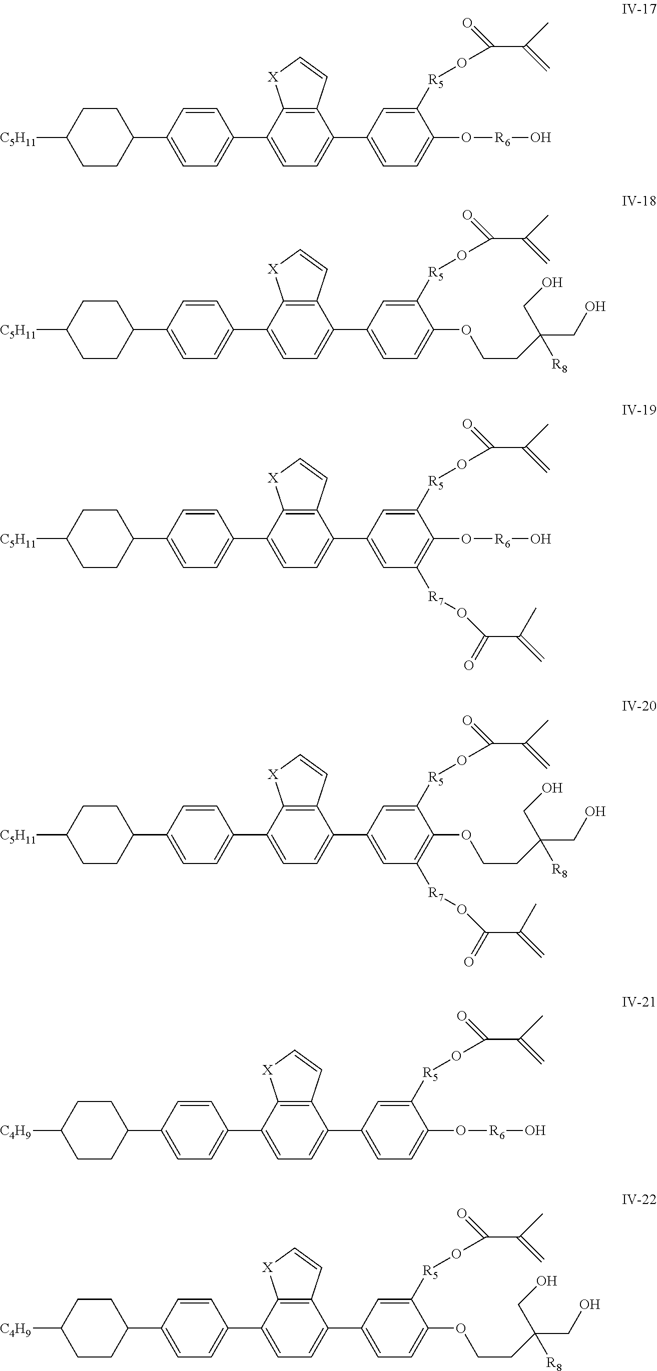 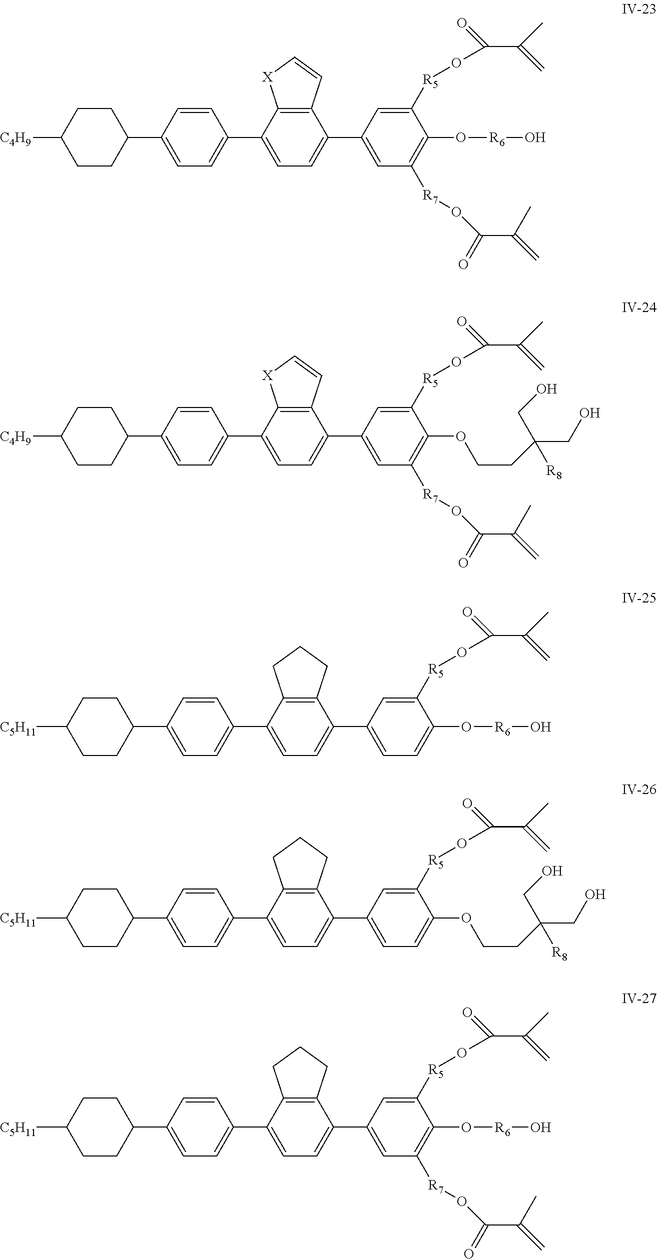 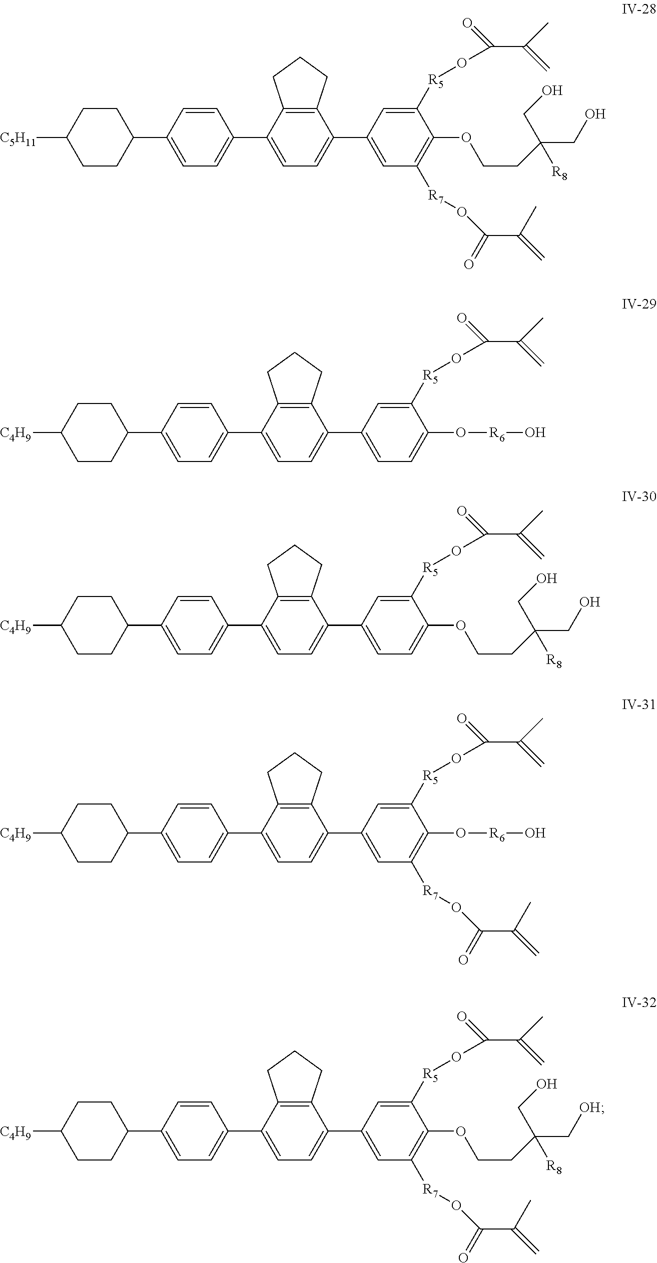
wherein R₅, R₆, R₇, and R₈ are independently selected from —H, —OH, —F, —Cl, —Br, —CN, —SCN, —NCS, an alkyl group having 1-10 carbon atoms, an alkoxy group having 1-10 carbon atoms, an alkenyl group having 2-10 carbon atoms, an alkenyloxy group having 2-10 carbon atoms, an alkynyl group having 2-10 carbon atoms, or an alkynyloxy group having 2-10 carbon atoms; wherein one or more —CH₂ groups in R₅, R₆, R₇, and R₈ are not replaced, or, one or more —CH₂ groups in R₅, R₆, R₇, and R₈ are independently replaced by —O—, —S—, —CO—, —C(O)O—, —OC(O)—, —CF₂O—, —OCF₂—, —CH₂CH₂—, —CH₂O—, —OCH₂—, —CH═CH—, or —C≡C—, and heteroatoms therein directly linked to C are not directly linked to each other; and wherein one or more H atoms in R₅, R₆, R₇, and R⁸ are unsubstituted, or, one or more H atoms in R₅, R₆, R₇, and R⁸ are independently substituted by F, Cl, Br, or I; and
X is independently selected from —S—, —N—, or —O—.

6. The liquid crystal composition of claim 1, wherein the first compound in the liquid crystal composition ranges from 0.01% to 1.50% by mass.

7. The liquid crystal composition of claim 1, further comprising at least one second compound represented by the following formula II: 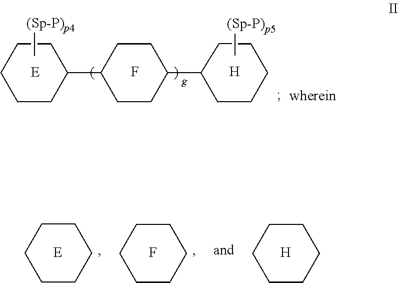
are independently selected from an aromatic ring, a heteroaromatic ring, a fused ring, an aliphatic ring, or an alicyclic heterocyclic ring; wherein one or more H atoms in 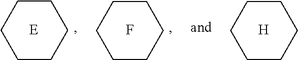
are unsubstituted or independently substituted by L⁰;
g is selected from 0, 1, or 2;
p4 and p5 are independently selected from 1, 2, or 3; and
definitions of P and Sp in formula II are the same as definitions of P and Sp in formula I.

8. The liquid crystal composition of claim 7, wherein the second compound is selected from at least one of a group consisting of compounds represented by the following formulae II-A to II-J: 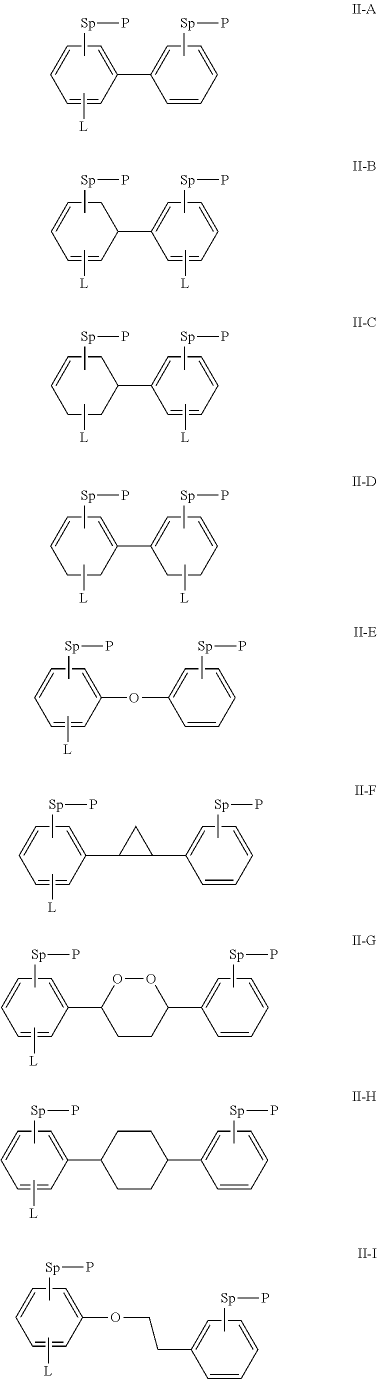 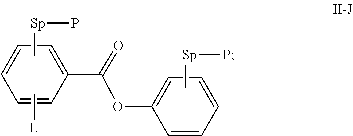
wherein L is independently selected from —F, —Cl, —Br, —I, —CN, —NO₂, —NCO, —NCS, —OCN, —SCN, a linear or branched alkyl group having 1-20 carbon atoms, an alkylidene group having 1-20 carbon atoms, an alkoxy group having 1-20 carbon atoms, a cycloalkyl group having 3-20 carbon atoms, an alkenyl group having 2-20 carbon atoms, an alkenylidene group having 2-20 carbon atoms, or an alkynyl group having 2-20 carbon atoms; wherein one or more —CH₂— groups not connected together in L are not replaced, or, one or more —CH₂— groups not connected together in L are independently replaced by —O—, —S—, —CO—, —C(O)O—, —OC(O)—, —CF₂O—, —OCF₂—, —CH₂CH₂—, —CH₂O—, —OCH₂—, —CH═CH—, or —C≡C—; and wherein one or more H atoms in L are unsubstituted, or, one or more H atoms in L are independently substituted by F, Cl, Br, or I; and
definitions of Sp-P in formulae II-A to II-J are the same as definitions of Sp-P in formulae III to IV.

9. The liquid crystal composition of claim 7, wherein the second compound is selected from at least one of a group consisting of compounds represented by the following formulae V-A to V-J: 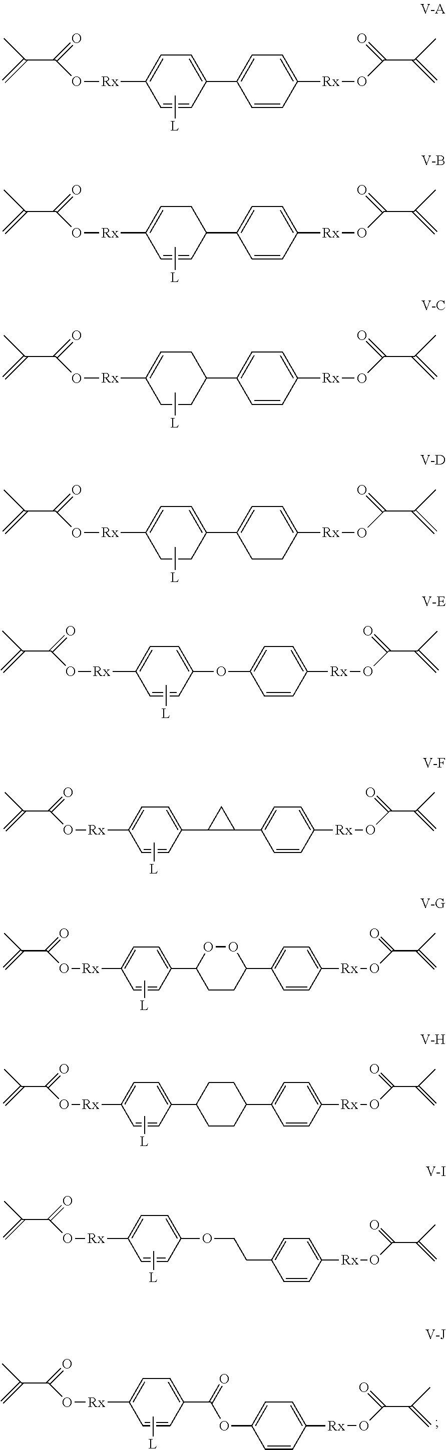
wherein Rx is independently selected from an alkylidene group having 1-10 carbon atoms, an alkyleneoxy group having 1-10 carbon atoms, or an alkenylidene group having 2-10 carbon atoms;
wherein one or more —CH₂ groups in Rx are not replaced; or, one or more —CH₂ groups in Rx are independently replaced by —O—, —S—, —CO—, —C(O)O—, —OC(O)—, —CF₂O—, —OCF₂—, —CH₂CH₂—, —CH₂O, —OCH₂—, —CH═CH—, or —C≡C—, and heteroatoms therein directly linked to C are not directly linked to each other; and
wherein one or more H atoms in Rx are unsubstituted, or, one or more H atoms in Rx are independently substituted by F, Cl, Br, or I; and
wherein definitions of L in formulae V-A to V-J are the same as definitions of L in formulae II-A to II-J.

10. The liquid crystal composition of claim 7, wherein the first compound and the second compound in the liquid crystal composition independently ranges from 0.01% to 1.50% by mass.

11. A display panel comprising:
a first substrate;
a second substrate disposed on the first substrate; and
a liquid crystal layer disposed between the first substrate and the second substrate;
wherein the liquid crystal layer comprises a liquid crystal composition comprising at least one first compound represented by the following formula I: 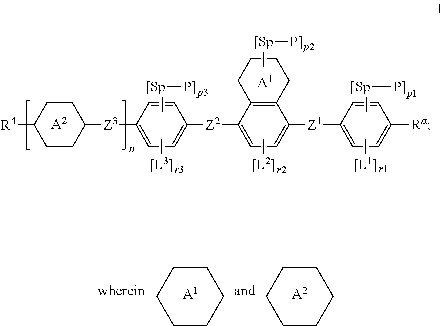
are independently selected from an aromatic ring, a heteroaromatic ring, a fused ring, an aliphatic ring, or an alicyclic heterocyclic ring, wherein one or more H atoms in 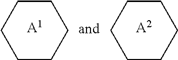
are unsubstituted or independently substituted by L⁰;
Z¹, Z², and Z³ are independently selected from a single bond, —O—, —S—, —CO—, —C(O)O—, —OC(O)—, —CF₂O—, —OCF₂—, —CH₂CH₂—, —CH₂O—, —OCH₂—, —CH═CH—, —C≡C—, an alkylidene group having 1-10 carbon atoms, an alkenylidene group having 2-10 carbon atoms, or an alkynyl group having 2-10 carbon atoms; wherein one or more —CH₂— groups not connected together in Z¹, Z², and Z³ are not replaced, or, one or more —CH₂— groups not connected together in Z¹, Z², and Z³ are independently replaced by —O—, —S—, —CO—, —C(O)O—, —OC(O)—, —CF₂O—, —OCF₂—, —CH₂CH₂—, —CH₂O—, —OCH₂—, —CH═CH—, or —C≡C—; and wherein one or more H atoms in Z¹, Z², and Z³ are unsubstituted, or, one or more H atoms in Z¹, Z², and Z³ are independently substituted by F, Cl, Br, or I;
L⁰, L¹, L², and L³ are independently selected from —F, —Cl, —Br, —I, —CN, —NO₂, —NCO, —NCS, —OCN, —SCN, a linear or branched alkyl group having 1-5 carbon atoms, or an alkoxy group having 1-5 carbon atoms; wherein one or more H atoms in L⁰, L¹, L², and L³ are unsubstituted, or, one or more H atoms in L⁰, L¹, L², and L³ are independently substituted by F or Cl;
P is a polymerizable group;
Sp is independently selected from a spacer group or a single bond;
R⁴ is selected from an alkyl group having 1-15 carbon atoms, an alkoxy group having 1-15 carbon atoms, a cycloalkyl group having 3-15 carbon atoms, an alkenyl group having 2-15 carbon atoms, an alkenyloxy group having 2-15 carbon atoms, an alkynyl group having 2-15 carbon atoms, an alkynyloxy group having 2-15 carbon atoms, or; 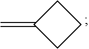
wherein one or more —CH₂— groups in R⁴ are not replaced, or, one or more —CH₂— groups in R⁴ are independently replaced by —CH═CH—, —C≡C—, —CF₂O—, 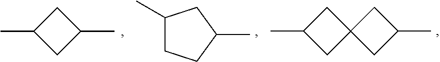
—CO—, —C(O)O—, —OC(O)—, or —O—; and wherein one or more H atoms in R⁴ are unsubstituted, or, one or more H atoms in R⁴ are independently substituted by F, Cl, Br, or I;
R^{a} is independently selected from a group capable of anchoring to a substrate;
n is selected from 0, 1, or 2;
p1, p2, and p3 are independently selected from 1, 2, or 3; and
r1, r2, and r3 are independently selected from 0, 1, 2, or 3.

12. The display panel of claim 11, wherein Sp-P in formula I is represented by the following formula III or formula IV, wherein the spacer group is represented by —Z⁴— in formula III and formula IV, and the polymerizable group is represented by 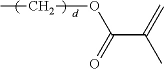
in formula III and 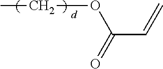
in formula IV; 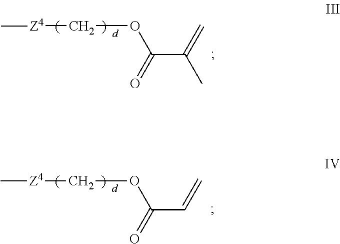
wherein Z⁴ is independently selected from a single bond, —O—, —S—, —CO—, —C(O)O—, —OC(O)—, —CF₂O—, —OCF₂—, —CH₂CH₂—, —CH₂O—, —OCH₂—, —CH═CH—, —C≡C—, an alkylidene group having 1-10 carbon atoms, an alkenylidene group having 2-10 carbon atoms, or an alkynyl group having 2-10 carbon atoms; wherein one or more —CH₂— groups not connected together in Z⁴ are not replaced, or, one or more —CH₂— groups not connected together in Z⁴ are independently replaced by —O—, —S—, —CO—, —C(O)O—, —OC(O)—, —CF₂O—, —OCF₂—, —CH₂CH₂—, —CH₂O—, —OCH₂—, —CH═CH—, —C≡C—; and wherein one or more H atoms in Z⁴ are unsubstituted, or, one or more H atoms in Z⁴ are independently substituted by F, Cl, Br, or I; and
d is any integer from 0 to 10.

13. The display panel of claim 11, wherein R^{a} is represented by the following formula V: 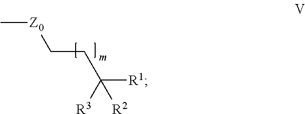
wherein Z₀ is selected from a single bond, —O—, —S—, —CO—, —C(O)O—, —OC(O)—, —CF₂O—, —OCF₂—, —CH₂CH₂—, —CH₂O—, —OCH₂—, —CH═CH—, —C≡C—, an alkylidene group having 1-10 carbon atoms, an alkenylidene group having 2-10 carbon atoms, or an alkynyl group having 2-10 carbon atoms; wherein one or more —CH₂— groups not connected together in Z₀ are not replaced, or, one or more —CH₂— groups not connected together in Z₀ are independently replaced by —O—, —S—, —CO—, —C(O)O—, —OC(O)—, —CF₂O—, —OCF₂—, —CH₂CH₂—, —CH₂O—, —OCH₂—, —CH═CH—, or —C≡C—; and wherein one or more H atoms in Z₀ are unsubstituted, or, one or more H atoms in Z₀ are independently substituted by F, Cl, Br, or I;
R¹, R², and R³ are independently selected from —H, —OH, —F, —Cl, —Br, —CN, —SCN, —NCS, an alkyl group having 1-10 carbon atoms, an alkoxy group having 1-10 carbon atoms, an alkenyl group having 2-10 carbon atoms, an alkenyloxy group having 2-10 carbon atoms, an alkynyl group having 2-10 carbon atoms, or an alkynyloxy group having 2-10 carbon atoms; wherein one or more end groups in R¹, R², and R³ are not replaced, or, one or more end groups in R¹, R², and R³ are independently replaced by —OH, —CN, or —CF₃; wherein one or more —CH₂— groups in R¹, R², and R³ are not replaced, or, one or more —CH₂— groups in R¹, R², and R³ are independently replaced by —O—, —S—, —CO—, —C(O)O—, —OC(O)—, —CF₂O—, —OCF₂—, —CH₂CH₂—, —CH₂O, —OCH₂—, —CH═CH—, or —C≡C—, and heteroatoms therein directly linked to C are not directly linked to each other; and wherein one or more H atoms in R¹, R², and R³ are unsubstituted, or, one or more H atoms in R¹, R², and R³ are independently substituted by F, Cl, Br, or I; and
m is any integer from 0 to 10.

14. The display panel of claim 11, wherein the first compound is selected from at least one of a group consisting of compounds represented by the following formulae I-A to I-Q: 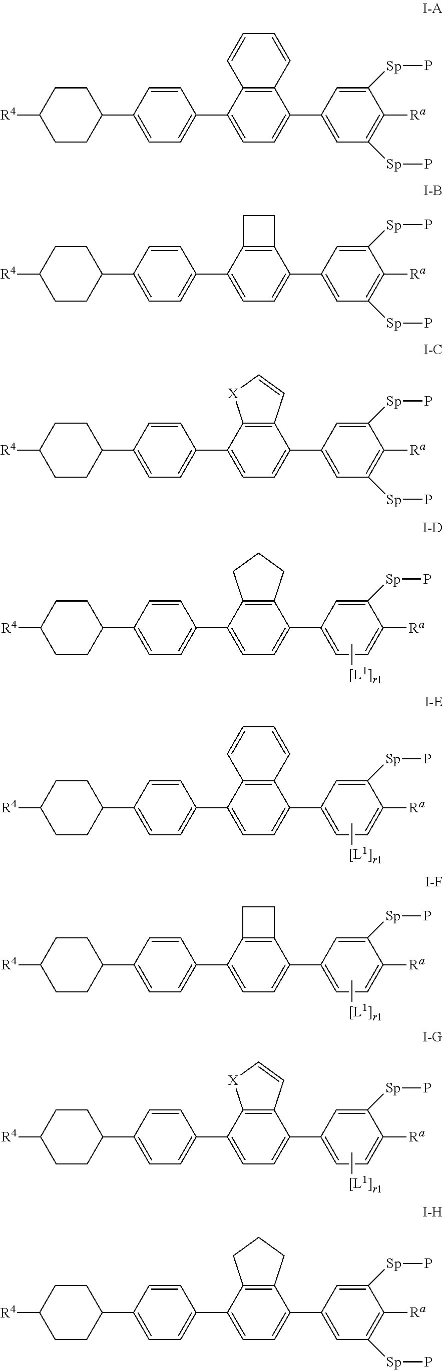 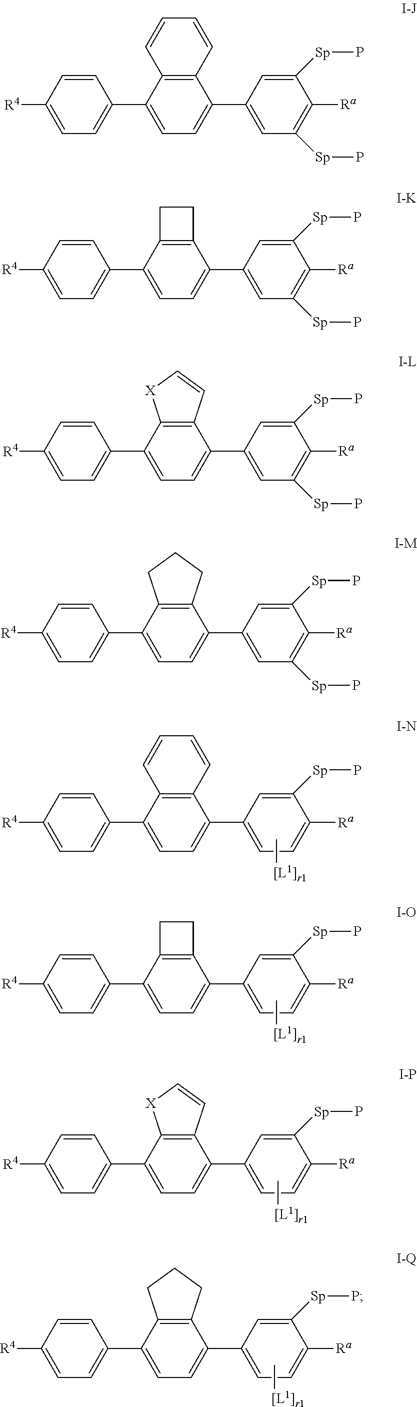
wherein R⁴ is independently selected from an alkyl group having 1-15 carbon atoms, an alkoxy group having 1-15 carbon atoms, a cycloalkyl group having 3-15 carbon atoms, an alkenyl group having 2-15 carbon atoms, an alkenyloxy group having 2-15 carbon atoms, an alkynyl group having 2-15 carbon atoms, an alkynyloxy group having 2-15 carbon atoms, or 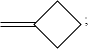
wherein one or more H atoms in R⁴ are unsubstituted, or, one or more H atoms in R⁴ are independently substituted by F, Cl, Br, or I;
X is independently selected from —S—, —N—, or —O—; and
definitions of L¹, Sp, P, R^{a}, and r1 in formulae I-A to I-Q are the same as definitions of L¹, Sp, P, R^{a}, and r1 in formula I.

15. The display panel of claim 11, wherein the first compound is selected from at least one of a group consisting of compounds represented by the following formulae IV-1 to IV-32: 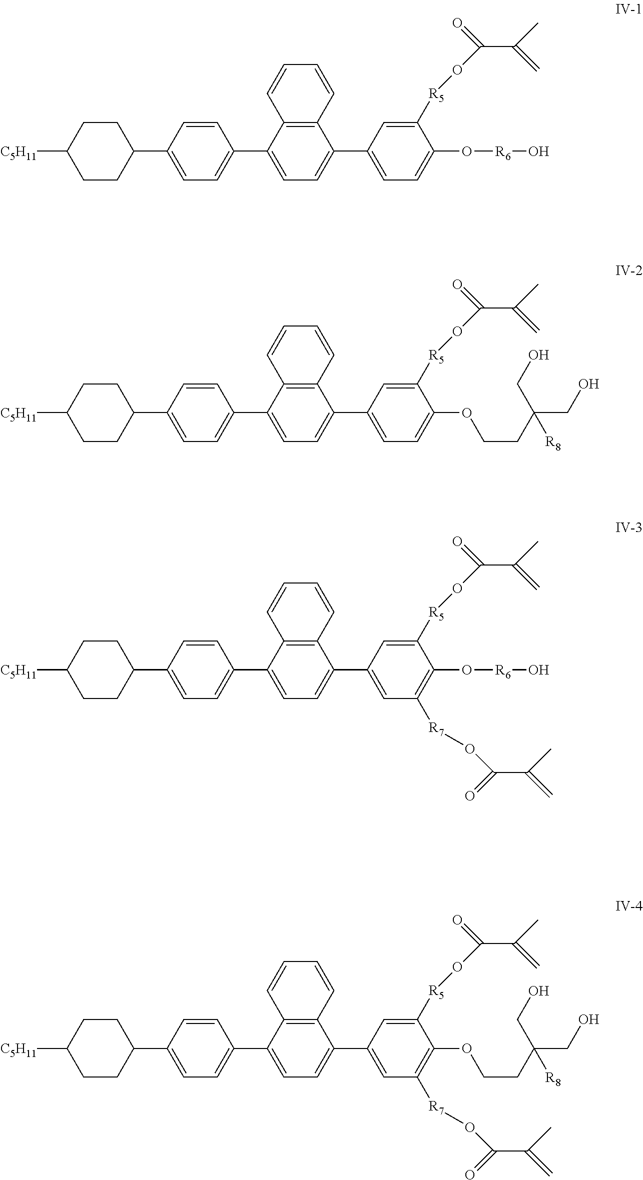 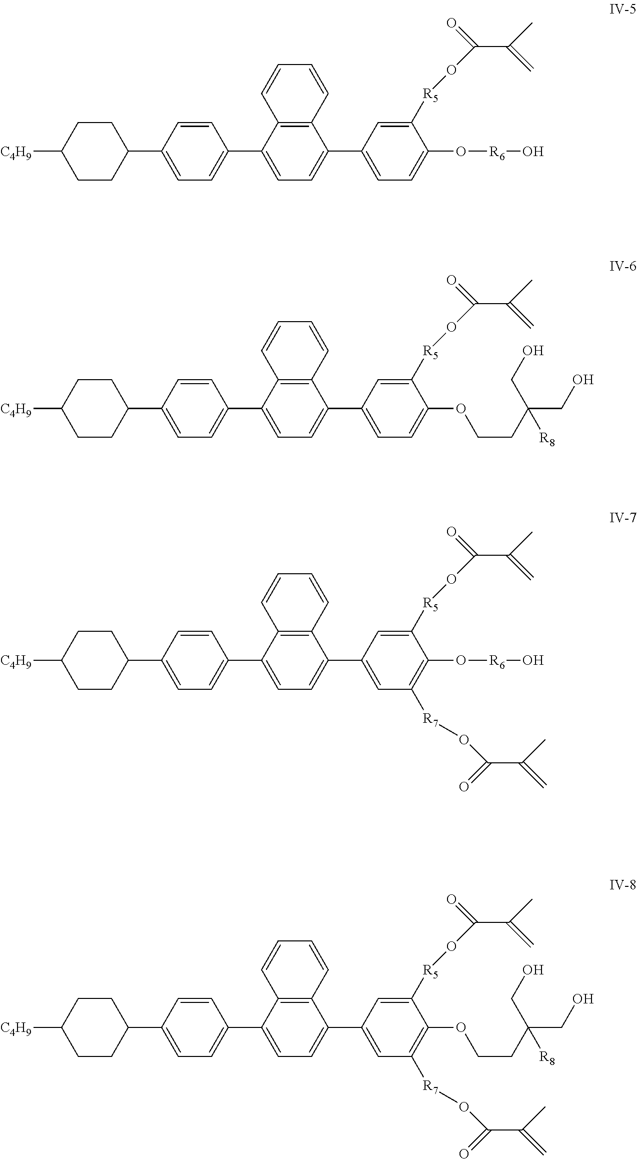 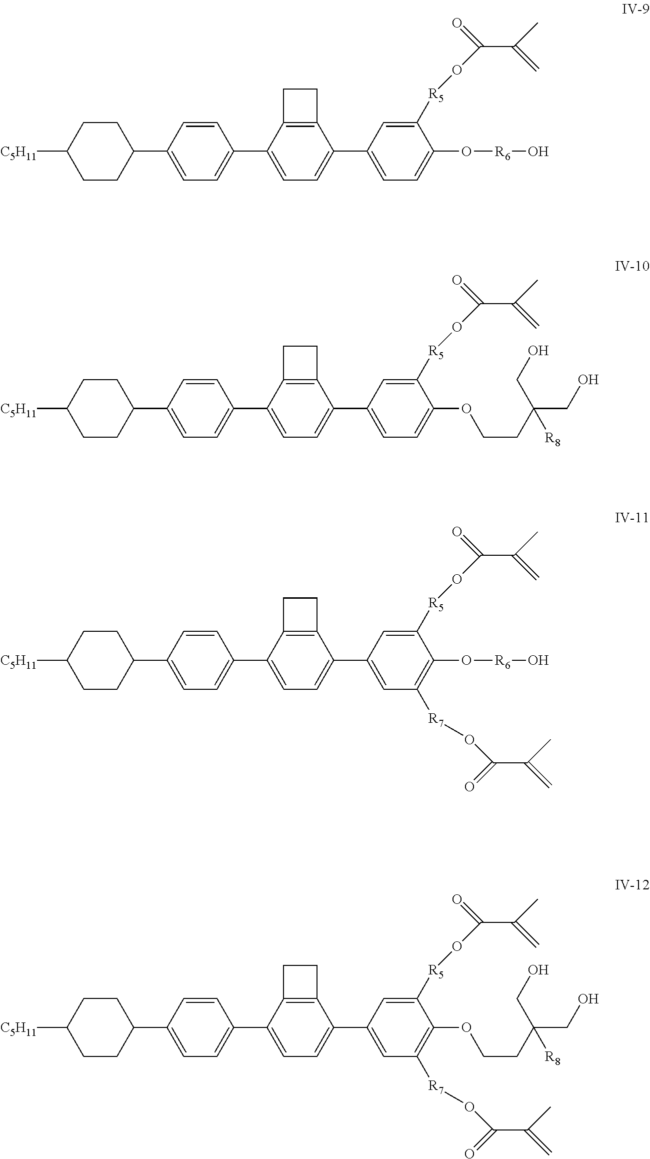 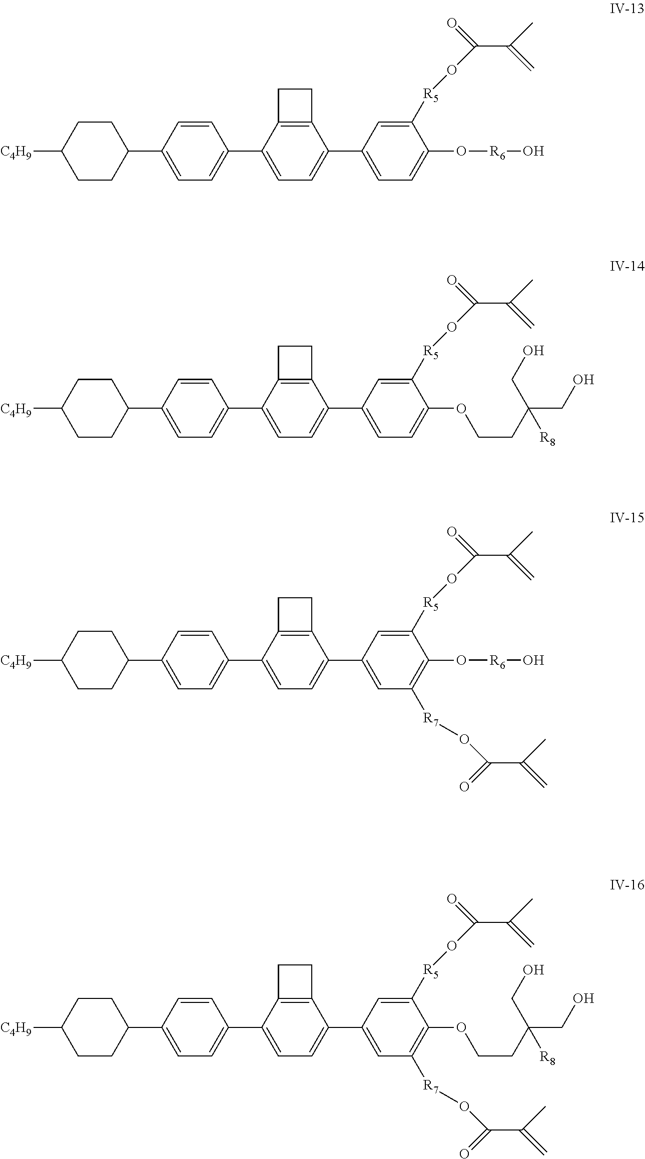 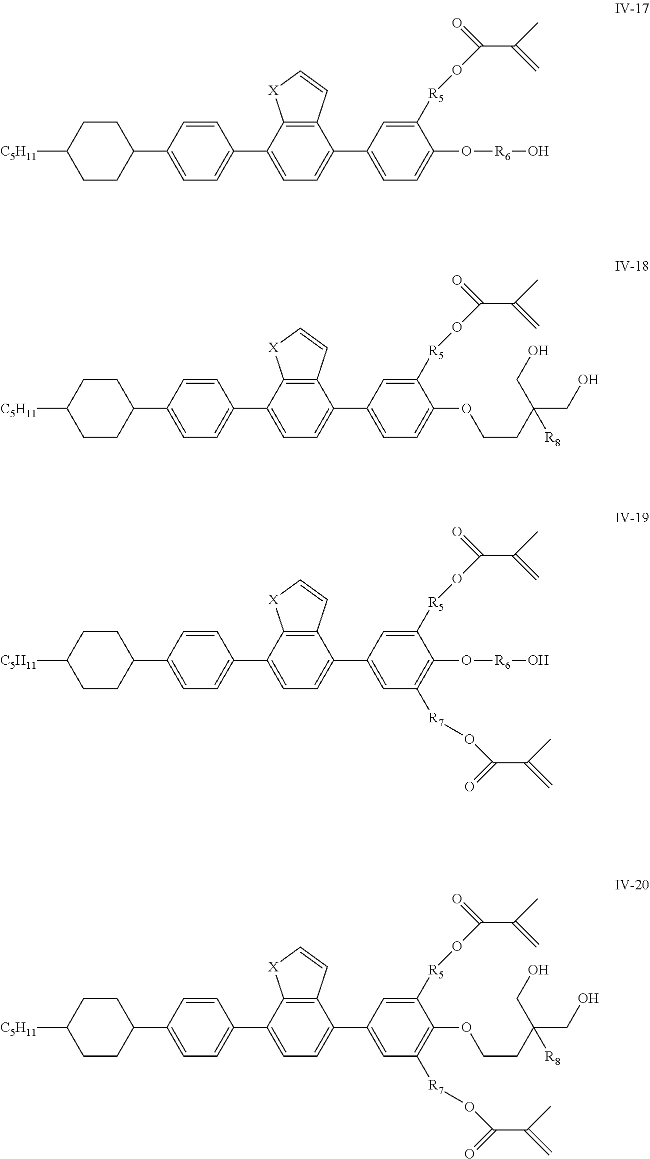 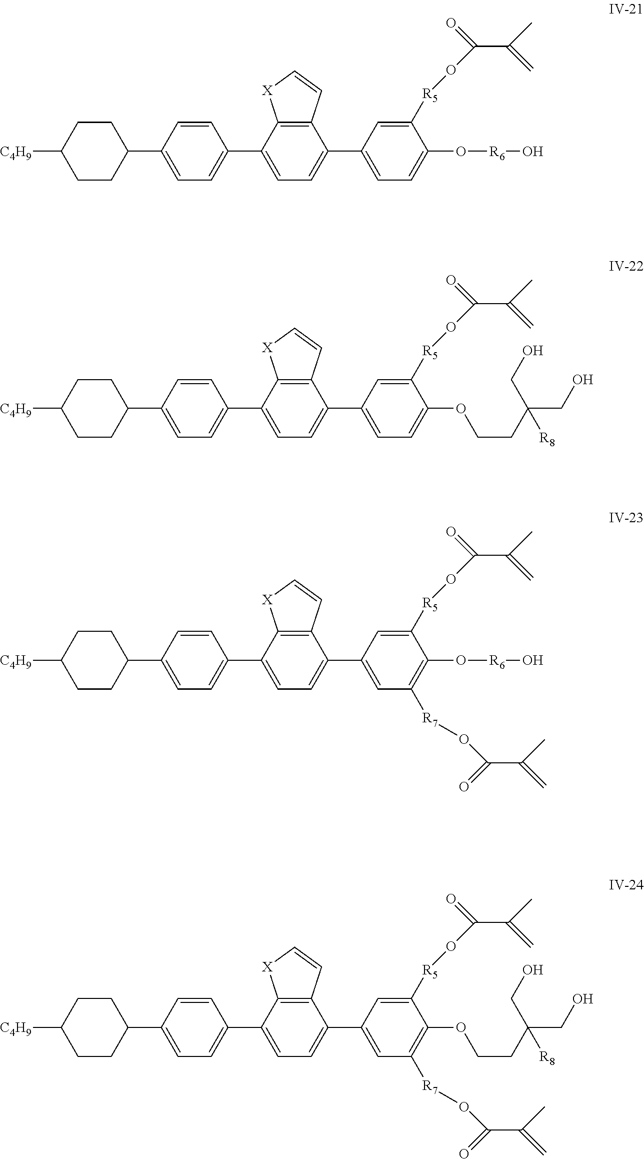 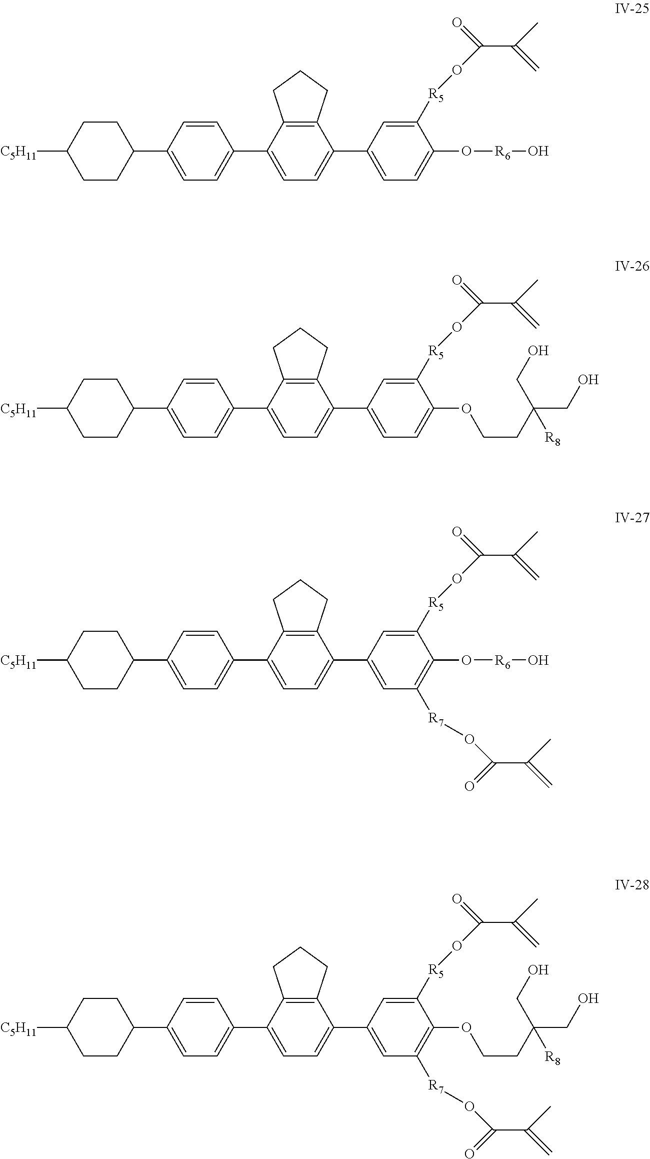 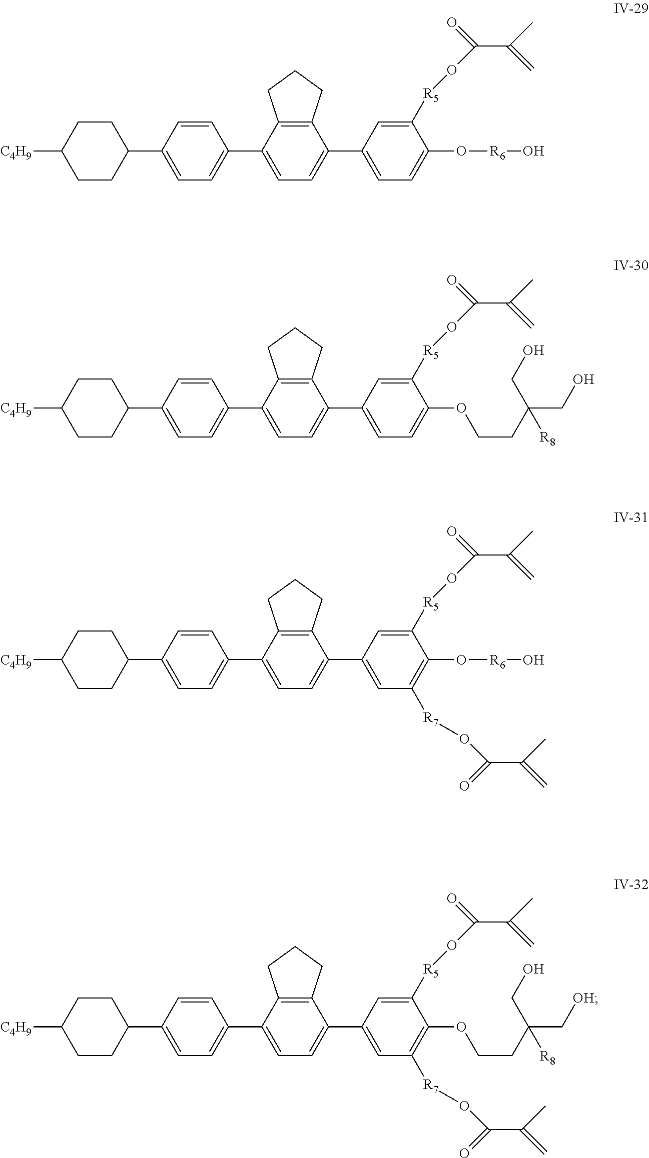
wherein R₅, R₆, R₇, and R⁸ are independently selected from —H, —OH, —F, —Cl, —Br, —CN, —SCN, —NCS, an alkyl group having 1-10 carbon atoms, an alkoxy group having 1-10 carbon atoms, an alkenyl group having 2-10 carbon atoms, an alkenyloxy group having 2-10 carbon atoms, an alkynyl group having 2-10 carbon atoms, or an alkynyloxy group having 2-10 carbon atoms; wherein one or more —CH₂ groups in R₅, R₆, R₇, and R⁸ are not replaced, or, one or more —CH₂ groups in R₅, R₆, R₇, and R₈ are independently replaced by —O—, —S—, —CO—, —C(O)O—, —OC(O)—, —CF₂O—, —OCF₂—, —CH₂CH₂—, —CH₂O—, —OCH₂—, —CH═CH—, or —C≡C—, and heteroatoms therein directly linked to C are not directly linked to each other; and wherein one or more H atoms in R₅, R₆, R₇, and R⁸ are unsubstituted, or, one or more H atoms in R₅, R₆, R₇, and R₈ are independently substituted by F, Cl, Br, or I.

16. The display panel of claim 11, wherein the first compound in the liquid crystal composition ranges from 0.01% to 1.50% by mass.

17. The display panel of claim 11, wherein the liquid crystal composition further comprises at least one second compound represented by the following formula II: 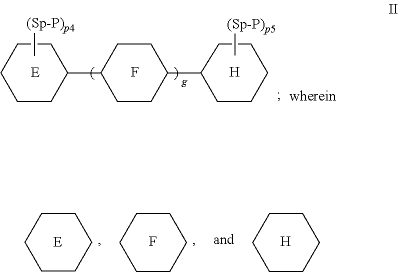
are independently selected from an aromatic ring, a heteroaromatic ring, a fused ring, an aliphatic ring, or an alicyclic heterocyclic ring; wherein one or more H atoms in 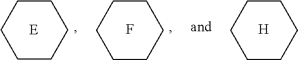
and are unsubstituted or independently substituted by L⁰;
g is selected from 0, 1, or 2;
p4 and p5 are independently selected from 1, 2, or 3; and
definitions of P and Sp in formula II are the same as definitions of P and Sp in formula I.

18. The display panel of claim 17, wherein the second compound is selected from at least one of a group consisting of compounds represented by the following formulae II-A to II-J: 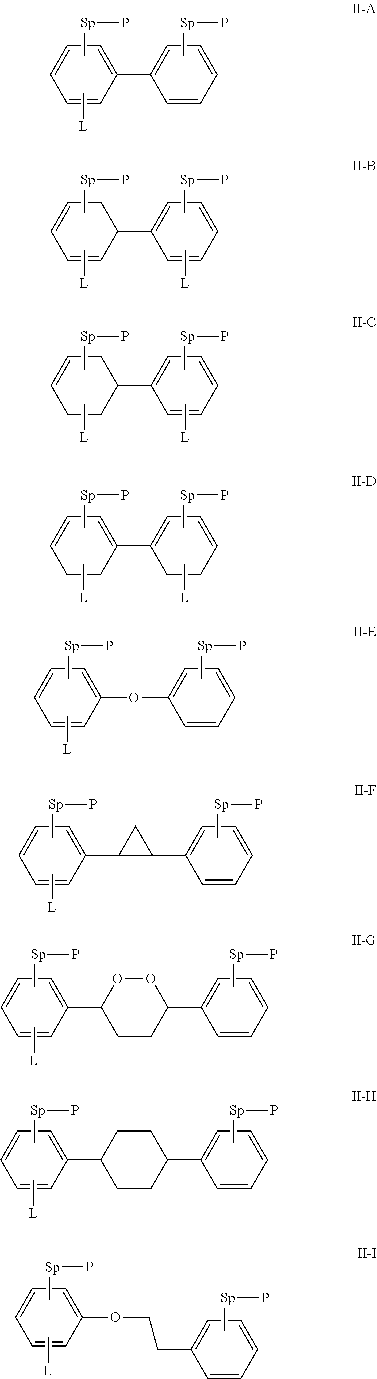 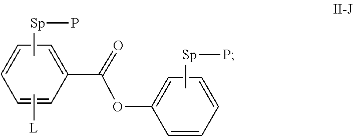
wherein L is independently selected from —F, —Cl, —Br, —I, —CN, —NO₂, —NCO, —NCS, —OCN, —SCN, a linear or branched alkyl group having 1-20 carbon atoms, an alkylidene group having 1-20 carbon atoms, an alkoxy group having 1-20 carbon atoms, a cycloalkyl group having 3-20 carbon atoms, an alkenyl group having 2-20 carbon atoms, an alkenylidene group having 2-20 carbon atoms, or an alkynyl group having 2-20 carbon atoms; wherein one or more —CH₂— groups not connected together in L are not replaced, or, one or more —CH₂— groups not connected together in L are independently replaced by —O—, —S—, —CO—, —C(O)O—, —OC(O)—, —CF₂O—, —OCF₂—, —CH₂CH₂—, —CH₂O—, —OCH₂—, —CH═CH—, or —C≡C—; and wherein one or more H atoms in L are unsubstituted, or, one or more H atoms in L are independently substituted by F, Cl, Br, or I; and
definitions of Sp-P in formulae II-A to II-J are the same as definitions of Sp-P in formulae III to IV.

19. The display panel of claim 17, wherein the second compound is selected from at least one of a group consisting of compounds represented by the following formulae V-A to V-J: 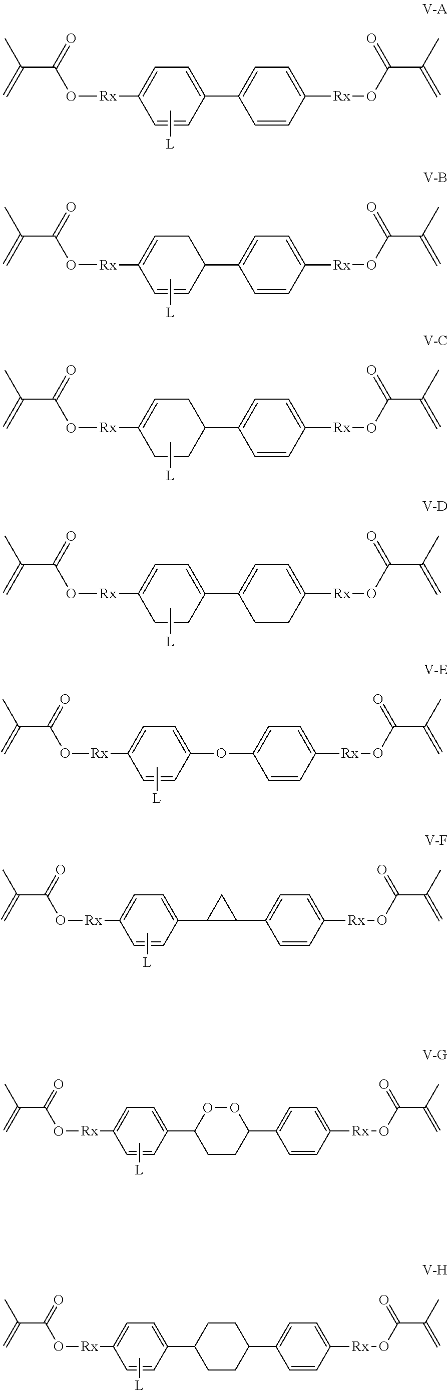 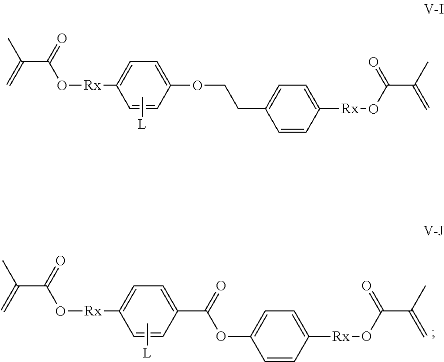
wherein Rx is independently selected from an alkylidene group having 1-10 carbon atoms, an alkyleneoxy group having 1-10 carbon atoms, or an alkenylidene group having 2-10 carbon atoms;
wherein one or more —CH₂ groups in Rx are not replaced; or, one or more —CH₂ groups in Rx are independently replaced by —O—, —S—, —CO—, —C(O)O—, —OC(O)—, —CF₂O—, —OCF₂—, —CH₂CH₂—, —CH₂O, —OCH₂—, —CH═CH—, or —C≡C—, and heteroatoms therein directly linked to C are not directly linked to each other; and
wherein one or more H atoms in Rx are unsubstituted, or, one or more H atoms in Rx are independently substituted by F, Cl, Br, or I; and
wherein definitions of L in formulae V-A to V-J are the same as definitions of L in formulae II-A to II-J.

20. The display panel of claim 17, wherein the first compound and the second compound in the liquid crystal composition independently ranges from 0.01% to 1.50% by mass.
